(19) United States
(12) Patent Application Publication
(10) Pub. No.: US 2026/0040165 A1
(43) Pub. Date: Feb. 5, 2026

(54) COMMUNICATION METHOD AND RELATED DEVICE

(71) Applicant: HUAWEI TECHNOLOGIES CO., LTD., Shenzhen (CN)

(72) Inventors: Yu Wang, Hangzhou (CN); Yunfei Qiao, Hangzhou (CN); Chuili Kong, Hangzhou (CN); Jun Wang, Hangzhou (CN)

(73) Assignee: HUAWEI TECHNOLOGIES CO., LTD., Shenzhen (CN)

(21) Appl. No.: 19/355,186

(22) Filed: Oct. 10, 2025

Related U.S. Application Data
(63) Continuation of application No. PCT/CN2024/087379, filed on Apr. 12, 2024.

(30) Foreign Application Priority Data
Apr. 13, 2023 (CN) 202310409237.4

(51) Int. Cl. H04W 36/00; H04W 36/08; H04W 84/06

(52) U.S. Cl. CPC H04W 36/0085; H04W 36/083; H04W 84/06

(57) ABSTRACT

A communication method and a related device, applicable to a non-terrestrial network (NTN) communication scenario such as a satellite network. In the method, a terminal device receives first information sent by a network device, where the first information includes N pieces of configuration information, the N pieces of configuration information are respectively used to configure N communication resources, and N is an integer greater than 1; the terminal device receives second information sent by the network device, where the second information indicates M communication resources in the N communication resources, and M is a positive integer less than or equal to N; and the terminal device measures at least one of the M communication resources.

### CROSS-REFERENCE TO RELATED APPLICATIONS

This application is a continuation of International Application No. PCT/CN2024/087379, filed on Apr. 12, 2024, which claims priority to Chinese Patent Application No. 202310409237.4, filed on Apr. 13, 2023. The disclosures of the aforementioned applications are hereby incorporated by reference in their entireties.

### TECHNICAL FIELD

The embodiments relate to the field of communication technologies and to a communication method and a related device.

### BACKGROUND

In a communication system, a network device may send a broadcast signal, and a communication resource may be configured by using the broadcast signal (for example, the communication resource may include a communication resource of the network device and a communication resource of a neighboring network device that possibly exists), so that a receiver of the broadcast signal can determine a corresponding communication resource based on the information. For example, when the receiver of the information is a terminal device, the terminal device can obtain a network service based on the communication resource.

Generally, an example in which the network device is a ground base station is used. Because the ground base station and another neighboring ground base station may be stationary at certain places on the ground, communication resources indicated by broadcast signals sent by the ground base station at different moments may remain unchanged.

However, the network device may not be stationary on the ground. For example, the network device may be a device such as a satellite, an airplane, or an uncrewed aerial vehicle. In this case, because the network device moves at a high speed, a communication resource of the network device or a neighboring network device may change frequently. Consequently, once the communication resource of the network device and/or the communication resource of the neighboring network device change, a changed communication resource may be reconfigured by using a broadcast signal, causing high signaling overheads and implementation complexity.

### SUMMARY

The embodiments provide a communication method and a related device and is applicable to a non-terrestrial network (NTN) communication system. When a network device moves and a communication resource indicated by the network device changes, the network device can dynamically activate M communication resources in N communication resources by using second information, so that the network device may not reconfigure a changed communication resource, reducing signaling overheads and implementation complexity, and improving communication efficiency.

A first aspect of the embodiments provides a communication method and the method is applicable to an NTN communication system. The method is performed by a terminal device, or the method is performed by a part of components (for example, a processor, a chip, or a chip system) in the terminal device, or the method may be implemented by a logic module or software that can implement all or some functions of the terminal device. In the first aspect and possible embodiments of the first aspect, an example in which the method is performed by a terminal device is used for description. In the method, a terminal device receives first information, where the first information includes N pieces of configuration information, the N pieces of configuration information are respectively used to configure N communication resources, and N is an integer greater than 1; the terminal device receives second information, where the second information indicates M communication resources in the N communication resources, and M is a positive integer less than or equal to N; and the terminal device measures at least one of the M communication resources, to assist in mobility management of a non-terrestrial network communication system.

Based on the foregoing solution, the N pieces of configuration information included in the first information received by the terminal device are respectively used to configure the N communication resources, and the second information received by the terminal device indicates the M communication resources in the N communication resources, so that the terminal device can determine the M communication resources based on the first information and the second information, and the terminal device can measure at least one of the M communication resources. Therefore, when a network device moves and a communication resource indicated by the network device changes, the network device can dynamically activate (enable, turn on, or the like) the M communication resources in the N communication resources by using the second information, so that the network device may not reconfigure a changed communication resource, reducing signaling overheads and implementation complexity, and improving communication efficiency.

It may be understood that a network device (for example, a first network device) in the embodiments may be a network device with mobility in an NTN communication system, for example, a satellite, an airplane, or an uncrewed aerial vehicle.

In a possible embodiment of the first aspect, the mobility management includes at least one of cell handover, cell reselection, registration area update, and tracking area update.

Based on the foregoing solution, after the terminal device determines the M communication resources based on the first information and the second information, the terminal device can measure at least one of the M communication resources, to assist the NTN communication system in performing at least one of the foregoing mobility management, to implement management on at least one of the following aspects: terminal device location information, security, and service continuity.

In a possible embodiment of the first aspect, the N pieces of configuration information include k pieces of first configuration information and N-k pieces of second configuration information, and k communication resources configured by using the k pieces of first configuration information are used for mobility management upon a communication resource change, where k is a positive integer.

In a possible embodiment of the first aspect, the N communication resources configured by using the N pieces of configuration information include k first communication resources configured by using k pieces of first configuration information and N-k second communication resources configured by using N-k pieces of first configuration information.

Before the communication resource changes, a quantity of communication resources carried by a satellite in the NTN communication system is equal to a quantity of second communication resources, and k is a positive integer.

Optionally, that the k communication resources are used for mobility management upon a communication resource change may be understood as that, before the communication resource of the network device and/or a communication resource of a neighboring network device change, the quantity of communication resources carried by the satellite in the NTN communication system is equal to the quantity of second communication resources (for example, N−k). When the communication resource of the network device and/or the communication resource of the neighboring network device change, one or more resources of the k communication resources are added to the communication resources carried by the satellite in the NTN communication system, and the second communication resources originally carried by the satellite in the NTN communication system may remain unchanged, or one or more of the N−k second communication resources may be removed. This is not limited herein. Correspondingly, that the k communication resources are used for mobility management upon a communication resource change may be expressed as follows: one or more of the k communication resources are communication resources used for mobility management in a signal coverage area, in a movement direction of the network device, the network device is to enter (or a signal coverage area the network device has entered).

Optionally, the second information is used to determine the M communication resources in the N communication resources, and the k communication resources in the N communication resources are used for mobility management upon a communication resource change. For example, before the communication resource of the network device and/or the communication resource of the neighboring network device change, the M communication resources indicated by the second information may not include one or more of the k communication resources. After the communication resource of the network device and/or the communication resource of the neighboring network device change, the M communication resources indicated by the second information may include one or more of the k communication resources.

Based on the foregoing solution, the N pieces of configuration information included in the first information sent by the network device include the k pieces of configuration information, and the k communication resources that are configured are used for mobility management upon a communication resource change, so that a receiver of the first information can determine, when the communication resource of the network device and/or the communication resource of the neighboring network device change, that one or more of the k communication resources are available communication resources.

In a possible embodiment of the first aspect, the N communication resources include a communication resource at a current moment and/or a communication resource at one or more future moments.

Based on the foregoing solution, in the N pieces of configuration information included in the first information sent by the network device, the N communication resources configured by using the N pieces of configuration information include the communication resource at the current moment and/or the communication resource at one or more future moments, so that a receiver of the first information can determine the communication resource at the current moment and/or the communication resource at one or more future moments based on the first information.

In a possible embodiment of the first aspect, the communication resource includes any one of the following: a cell indicated by a physical cell identifier (PCI), a broadcast beam, a traffic beam, and a synchronization signal block (synchronization signal/physical broadcast channel block, SS/PBCH block, SS/PBCH block, or SSB).

Based on the foregoing solution, the communication resource configured by using the first information sent by the network device may include any one of the foregoing, so that the foregoing solution can be applied to a process of configuring and dynamically activating multiple types of communication resources.

In a possible embodiment of the first aspect, the method further includes: the terminal device sends third information, where the third information indicates a result of the measurement.

Optionally, the third information may include a measurement report of at least one of the M communication resources, or the third information may include information in a measurement report of at least one of the M communication resources.

Based on the foregoing solution, after the terminal device measures at least one of the M communication resources, the terminal device may send the third information indicating measurement information of the measurement process, so that the network device determines, based on the third information, communication quality of the terminal device on the at least one communication resource, and may subsequently schedule the terminal device based on the third information.

In a possible embodiment of the first aspect, the second information includes indexes of the M communication resources.

Based on the foregoing solution, the second information used to determine the M communication resources may include the indexes of the M communication resources, so that a receiver of the second information can determine the M communication resources in an explicit indication manner.

In a possible embodiment of the first aspect, the second information includes effective time information corresponding to the N communication resources, and the effective time information and the current moment are used to determine the M pieces of configuration information; and/or the second information includes shift information corresponding to the N communication resources, and the shift information and the current moment are used to determine the M pieces of configuration information.

Based on the foregoing solution, the second information used to determine the M communication resources may include the effective time information and/or the shift information corresponding to the N communication resources, so that a receiver of the second information can determine the M communication resources in an implicit indication manner.

In a possible embodiment of the first aspect, each of the N communication resources corresponds to a first identifier and a second identifier. The first identifier is used to identify a resource index of each communication resource, and the second identifier is used to identify space domain information and/or polarization domain information of each communication resource. The M communication resources meet any one of the following: a first identifier corresponding to one of the M communication resources is the same as a first identifier corresponding to a target communication resource, and a second identifier corresponding to one of the M communication resources is different from a second identifier corresponding to the target communication resource, where the target communication resource is a communication resource other than the M communication resources in the N communication resources. Alternatively, a first identifier corresponding to any one of the M communication resources is different from the first identifier corresponding to the target communication resource.

Optionally, when the communication resource is a cell indicated by a PCI, the first identifier may be the PCI, and the second identifier may be a space domain identifier and/or a polarization domain identifier corresponding to the cell indicated by the PCI.

Optionally, when the communication resource is an SSB, the first identifier may be an SSB index, and the second identifier may be a space domain identifier and/or a polarization domain identifier corresponding to the SSB.

Optionally, when the communication resource is a beam (for example, a broadcast beam or a traffic beam), the first identifier may be a beam index, and the second identifier may be a space domain identifier and/or a polarization domain identifier corresponding to the beam.

Based on the foregoing solution, in the N communication resources configured by using the first information sent by the network device, when resource indexes of different communication resources are the same, the different communication resources may have different space domains and/or different polarization domains, or different communication resources may have different resource indexes, to provide multiple implementations in which the network device configures the N communication resources, improving flexibility of implementing the solution.

Optionally, the first information is carried in at least one of a system information block (SIB) 2, a SIB3, and a SIB4.

Optionally, the second information is carried in an XnAP (an XnAP message is used to carry signaling between different access network devices), a medium access control control element (MAC CE), downlink control information (DCI), a SIBx (a value of x ranges from 1 to 19), a radio resource control (RRC) configuration message, an RRC reconfiguration message, or the like.

In a possible embodiment of the first aspect, the method further includes: the terminal device receives fourth information, where the fourth information indicates that P communication resources in the N communication resources are unavailable communication resources, and P is a positive integer.

Based on the foregoing solution, when the network device moves and the communication resource indicated by the network device changes, the network device may dynamically deactivate the P communication resources in the N communication resources by using the fourth information, so that the network device may not reconfigure a changed communication resource, reducing signaling overheads and implementation complexity, and improving communication efficiency.

In addition, when the terminal device determines, based on the fourth information, that the P communication resources are unavailable communication resources, the terminal device may not perform measurement based on the P communication resources, reducing unnecessary overheads.

A second aspect of the embodiments provides a communication method and the method is applicable to an NTN communication system. The method is performed by a first network device, or the method is performed by a part of components (for example, a processor, a chip, or a chip system) in the first network device, or the method may be implemented by a logic module or software that can implement all or some functions of the first network device. In the second aspect and possible embodiments of the second aspect, an example in which the method is performed by a first network device is used for description. In the method, a first network device sends first information, where the first information includes N pieces of configuration information, the N pieces of configuration information are respectively used to configure N communication resources, and N is an integer greater than 1; and the first network device sends second information, where the second information indicates M communication resources in the N communication resources, and M is a positive integer less than or equal to N.

Based on the foregoing solution, the N pieces of configuration information included in the first information sent by the first network device are respectively used to configure the N communication resources, and the second information sent by the first network device indicates the M communication resources in the N communication resources, so that a receiver of the first information and the second information can determine the M communication resources based on the first information and the second information. Therefore, when the first network device moves and the communication resource indicated by the first network device changes, the first network device can dynamically activate (enable, turn on, or the like) the M communication resources in the N communication resources by using the second information, so that the first network device may not reconfigure a changed communication resource, reducing signaling overheads and implementation complexity, and improving communication efficiency.

It may be understood that, when the N communication resources configured by using the N pieces of configuration information in the first information include a communication resource of a neighboring network device of the first network device, before the first network device sends the first information, the first network device may receive one or more pieces of configuration information of the neighboring network device (the one or more pieces of configuration information is used to configure the communication resource of the neighboring network device), so that the first network device determines the N pieces of configuration information based on the one or more pieces of configuration information.

It may be understood that the first network device may be a network device with mobility in the NTN communication system, for example, a satellite, an airplane, or an uncrewed aerial vehicle.

In a possible embodiment of the second aspect, the N pieces of configuration information include k pieces of first configuration information and N-k pieces of second configuration information, and k communication resources configured by using the k pieces of first configuration information are used for mobility management upon a communication resource change, where k is a positive integer.

In a possible embodiment of the second aspect, the N communication resources configured by using the N pieces of configuration information include k first communication resources configured by using k pieces of first configuration information and N-k second communication resources configured by using N-k pieces of first configuration information. Before the communication resource changes, a quantity of communication resources carried by a satellite in the NTN communication system is equal to a quantity of second communication resources, and k is a positive integer.

Optionally, that the k communication resources are used for mobility management upon a communication resource change may be understood as that, before the communication resource of the network device and/or a communication resource of a neighboring network device change, the quantity of communication resources carried by the satellite in the NTN communication system is equal to the quantity of second communication resources (for example, N−k). When the communication resource of the network device and/or the communication resource of the neighboring network device change, one or more resources of the k communication resources are added to the communication resources carried by the satellite in the NTN communication system, and the second communication resources originally carried by the satellite in the NTN communication system may remain unchanged, or one or more of the N−k second communication resources may be removed. This is not limited herein. Correspondingly, that the k communication resources are used for mobility management upon a communication resource change may be expressed as follows: one or more of the k communication resources are communication resources used for mobility management in a signal coverage area, in a movement direction of the network device, the network device is to enter (or a signal coverage area the network device has entered).

Optionally, the second information is used to determine the M communication resources in the N communication resources, and the k communication resources in the N communication resources are used for mobility management upon a communication resource change. For example, before the communication resource of the network device and/or the communication resource of the neighboring network device change, the M communication resources indicated by the second information may not include one or more of the k communication resources. After the communication resource of the network device and/or the communication resource of the neighboring network device change, the M communication resources indicated by the second information may include one or more of the k communication resources.

Based on the foregoing solution, the N pieces of configuration information included in the first information sent by the first network device include the k pieces of configuration information, and the k communication resources that are configured are used for mobility management upon a communication resource change, so that a receiver of the first information can determine, when the communication resource of the first network device and/or the communication resource of the neighboring network device change, that one or more of the k communication resources are available communication resources.

In a possible embodiment of the second aspect, the N communication resources include a communication resource at a current moment and/or a communication resource at one or more future moments.

Based on the foregoing solution, in the N pieces of configuration information included in the first information sent by the first network device, the N communication resources configured by using the N pieces of configuration information include the communication resource at the current moment and/or the communication resource at one or more future moments, so that a receiver of the first information can determine the communication resource at the current moment and/or the communication resource at one or more future moments based on the first information.

In a possible embodiment of the second aspect, the communication resource includes any one of the following: a cell indicated by a physical cell identifier PCI, a broadcast beam, a traffic beam, and a synchronization signal block SSB.

Based on the foregoing solution, the communication resource configured by using the first information sent by the first network device may include any one of the foregoing, so that the foregoing solution can be applied to a process of configuring and dynamically activating multiple types of communication resources.

In a possible embodiment of the second aspect, the method further includes: the first network device receives third information, where the third information indicates a result of the measurement.

Optionally, the third information may include a measurement report of at least one of the M communication resources, or the third information may include information in a measurement report of at least one of the M communication resources.

Based on the foregoing solution, after a terminal device measures at least one of the M communication resources, the terminal device may send the third information indicating measurement information of the measurement process, so that the first network device determines, based on the third information, communication quality of the terminal device on the at least one communication resource, and may subsequently schedule the terminal device based on the third information.

In a possible embodiment of the second aspect, the second information includes indexes of the M communication resources.

Based on the foregoing solution, the second information used to determine the M communication resources may include the indexes of the M communication resources, so that a receiver of the second information can determine the M communication resources in an explicit indication manner.

In a possible embodiment of the second aspect, the second information includes effective time information corresponding to the N communication resources, and the effective time information and the current moment are used to determine the M pieces of configuration information; and/or the second information includes shift information corresponding to the N communication resources, and the shift information and the current moment are used to determine the M pieces of configuration information.

Based on the foregoing solution, the second information used to determine the M communication resources may include the effective time information and/or the shift information corresponding to the N communication resources, so that a receiver of the second information can determine the M communication resources in an implicit indication manner.

In a possible embodiment of the second aspect, each of the N communication resources corresponds to a first identifier and a second identifier. The first identifier is used to identify a resource index of each communication resource, and the second identifier is used to identify space domain information and/or polarization domain information of each communication resource. The M communication resources meet any one of the following: a first identifier corresponding to one of the M communication resources is the same as a first identifier corresponding to a target communication resource, and a second identifier corresponding to one of the M communication resources is different from a second identifier corresponding to the target communication resource, where the target communication resource is a communication resource other than the M communication resources in the N communication resources. Alternatively, a first identifier corresponding to any one of the M communication resources is different from the first identifier corresponding to the target communication resource.

Optionally, when the communication resource is a cell indicated by a PCI, the first identifier may be the PCI, and the second identifier may be a space domain identifier and/or a polarization domain identifier corresponding to the cell indicated by the PCI.

Optionally, when the communication resource is an SSB, the first identifier may be an SSB index, and the second identifier may be a space domain identifier and/or a polarization domain identifier corresponding to the SSB.

Optionally, when the communication resource is a beam (for example, a broadcast beam or a traffic beam), the first identifier may be a beam index, and the second identifier may be a space domain identifier and/or a polarization domain identifier corresponding to the beam.

Based on the foregoing solution, in the N communication resources configured by using the first information sent by the first network device, when resource indexes of different communication resources are the same, the different communication resources may have different space domains and/or different polarization domains, or different communication resources may have different resource indexes, to provide multiple implementations in which the first network device configures the N communication resources, improving flexibility of implementing the solution.

Optionally, the first information is carried in at least one of a system information block SIB2, a SIB3, and a SIB4.

Optionally, the second information is carried in an XnAP (an XnAP message is used to carry signaling between different access network devices), a medium access control control element (MAC CE), downlink control information (DCI), a SIBx (a value of x ranges from 1 to 19), a radio resource control (RRC) configuration message, an RRC reconfiguration message, or the like.

In a possible embodiment of the second aspect, the method further includes: the first network device sends fourth information, where the fourth information indicates that P communication resources in the N communication resources are unavailable communication resources, and P is a positive integer.

Based on the foregoing solution, when the first network device moves and the communication resource indicated by the first network device changes, the first network device may dynamically deactivate the P communication resources in the N communication resources by using the fourth information, so that the first network device may not reconfigure a changed communication resource, reducing signaling overheads and implementation complexity, and improving communication efficiency.

A third aspect of the embodiments provides a communication method and the method is applicable to an NTN communication system. The method is performed by a second network device, or the method is performed by a part of components (for example, a processor, a chip, or a chip system) in the second network device, or the method may be implemented by a logic module or software that can implement all or some functions of the second network device. In the third aspect and possible embodiments of the third aspect, an example in which the method is performed by a second network device is used for description. In the method, a second network device receives first information, where the first information includes N pieces of configuration information, the N pieces of configuration information are respectively used to configure N communication resources, and Nis an integer greater than 1; the second network device receives second information, where the second information indicates M communication resources in the N communication resources, and M is a positive integer less than or equal to N; and the second network device determines the M communication resources based on the first information and the second information.

Based on the foregoing solution, the N pieces of configuration information included in the first information received by the second network device are respectively used to configure the N communication resources, and the second information received by the second network device indicates the M communication resources in the N communication resources, so that the second network device can determine the M communication resources based on the first information and the second information. Therefore, when a first network device moves and a communication resource indicated by the first network device changes, the first network device can dynamically activate (enable, turn on, or the like) the M communication resources in the N communication resources by using the second information, so that the first network device may not reconfigure a changed communication resource, reducing signaling overheads and implementation complexity, and improving communication efficiency.

It may be noted that after the second network device determines the M communication resources based on the first information and the second information, the second network device may update neighboring cell relationship information (for example, a neighbor relation table (NRT) and/or a neighboring cell list (NCL)) based on one or more communication resources in the M communication resources, and the second network device may further determine, based on the neighboring cell relationship information (and other information that may exist, for example, ephemeris information of the second network device and ephemeris information of the first network device), one or more communication resources to be dynamically activated by the second network device subsequently, or the second network device may further perform another operation. This is not limited herein.

In a possible embodiment of the third aspect, the N pieces of configuration information include k pieces of first configuration information and N-k pieces of second configuration information, and k communication resources configured by using the k pieces of first configuration information are used for mobility management upon a communication resource change, where k is a positive integer.

In a possible embodiment of the third aspect, the N communication resources configured by using the N pieces of configuration information include k first communication resources configured by using k pieces of first configuration information and N−k second communication resources configured by using N−k pieces of first configuration information. Before the communication resource changes, a quantity of communication resources carried by a satellite in the NTN communication system is equal to a quantity of second communication resources, and k is a positive integer.

Optionally, that the k communication resources are used for mobility management upon a communication resource change may be understood as that, before the communication resource of the network device and/or a communication resource of a neighboring network device change, the quantity of communication resources carried by the satellite in the NTN communication system is equal to the quantity of second communication resources (for example, N−k). When the communication resource of the network device and/or the communication resource of the neighboring network device change, one or more resources of the k communication resources are added to the communication resources carried by the satellite in the NTN communication system, and the second communication resources originally carried by the satellite in the NTN communication system may remain unchanged, or one or more of the N-k second communication resources may be removed. This is not limited herein. Correspondingly, that the k communication resources are used for mobility management upon a communication resource change may be expressed as follows: one or more of the k communication resources are communication resources used for mobility management in a signal coverage area, in a movement direction of the network device, the network device is to enter (or a signal coverage area the network device has entered).

Optionally, the second information is used to determine the M communication resources in the N communication resources, and the k communication resources in the N communication resources are used for mobility management upon a communication resource change. For example, before the communication resource of the network device and/or the communication resource of the neighboring network device change, the M communication resources indicated by the second information may not include one or more of the k communication resources. After the communication resource of the network device and/or the communication resource of the neighboring network device change, the M communication resources indicated by the second information may include one or more of the k communication resources.

Based on the foregoing solution, the N pieces of configuration information included in the first information sent by the first network device include the k pieces of configuration information, and the k communication resources that are configured are used for mobility management upon a communication resource change, so that a receiver of the first information can determine, when the communication resource of the first network device and/or the communication resource of the neighboring network device change, that one or more of the k communication resources are available communication resources.

In a possible embodiment of the third aspect, the N communication resources include a communication resource at a current moment and/or a communication resource at one or more future moments.

Based on the foregoing solution, in the N pieces of configuration information included in the first information sent by the first network device, the N communication resources configured by using the N pieces of configuration information include the communication resource at the current moment and/or the communication resource at one or more future moments, so that a receiver of the first information can determine the communication resource at the current moment and/or the communication resource at one or more future moments based on the first information.

In a possible embodiment of the third aspect, the communication resource includes any one of the following: a cell indicated by a physical cell identifier (PCI), a broadcast beam, a traffic beam, and a synchronization signal block (synchronization signal/physical broadcast channel block, SS/PBCH block, SS/PBCH block, or SSB).

Based on the foregoing solution, the communication resource configured by using the first information sent by the first network device may include any one of the foregoing, so that the foregoing solution can be applied to a process of configuring and dynamically activating multiple types of communication resources.

In a possible embodiment of the third aspect, the second information includes indexes of the M communication resources.

Based on the foregoing solution, the second information used to determine the M communication resources may include the indexes of the M communication resources, so that a receiver of the second information can determine the M communication resources in an explicit indication manner.

In a possible embodiment of the third aspect, the second information includes effective time information corresponding to the N communication resources, and the effective time information and the current moment are used to determine the M pieces of configuration information; and/or the second information includes shift information corresponding to the N communication resources, and the corresponding shift information and the current moment are used to determine the M pieces of configuration information.

Based on the foregoing solution, the second information used to determine the M communication resources may include the effective time information and/or the shift information corresponding to the N communication resources, so that a receiver of the second information can determine the M communication resources in an implicit indication manner.

In a possible embodiment of the third aspect, each of the N communication resources corresponds to a first identifier and a second identifier. The first identifier is used to identify a resource index of each communication resource, and the second identifier is used to identify space domain information and/or polarization domain information of each communication resource. The M communication resources meet any one of the following: a first identifier corresponding to one of the M communication resources is the same as a first identifier corresponding to a target communication resource, and a second identifier corresponding to one of the M communication resources is different from a second identifier corresponding to the target communication resource, where the target communication resource is a communication resource other than the M communication resources in the N communication resources. Alternatively, a first identifier corresponding to any one of the M communication resources is different from the first identifier corresponding to the target communication resource.

Optionally, when the communication resource is a cell indicated by a PCI, the first identifier may be the PCI, and the second identifier may be a space domain identifier and/or a polarization domain identifier corresponding to the cell indicated by the PCI.

Optionally, when the communication resource is an SSB, the first identifier may be an SSB index, and the second identifier may be a space domain identifier and/or a polarization domain identifier corresponding to the SSB.

Optionally, when the communication resource is a beam (for example, a broadcast beam or a traffic beam), the first identifier may be a beam index, and the second identifier may be a space domain identifier and/or a polarization domain identifier corresponding to the beam.

Based on the foregoing solution, in the N communication resources configured by using the first information sent by the first network device, when resource indexes of different communication resources are the same, the different communication resources may have different space domains and/or different polarization domains, or different communication resources may have different resource indexes, to provide multiple implementations in which the first network device configures the N communication resources, improving flexibility of implementing the solution.

Optionally, the first information is carried in at least one of a system information block (SIB) 2, a SIB3, and a SIB4.

Optionally, the second information is carried in an XnAP (an XnAP message is used to carry signaling between different access network devices), a medium access control control element (MAC CE), downlink control information (DCI), a SIBx (a value of x ranges from 1 to 19), a radio resource control (RRC) configuration message, an RRC reconfiguration message, or the like.

In a possible embodiment of the third aspect, the method further includes: the second network device receives fourth information, where the fourth information indicates that P communication resources in the N communication resources are unavailable communication resources, and P is a positive integer.

Based on the foregoing solution, when the first network device moves and the communication resource indicated by the first network device changes, the first network device may dynamically deactivate the P communication resources in the N communication resources by using the fourth information, so that the first network device may not reconfigure a changed communication resource, reducing signaling overheads and implementation complexity, and improving communication efficiency.

A fourth aspect of the embodiments provides a communication apparatus. The apparatus is a terminal device, a part of components (for example, a processor, a chip, or a chip system) in the terminal device, or a logic module or software that can implement all or some functions of the terminal device. In the fourth aspect and possible embodiments of the fourth aspect, an example in which the communication apparatus is a terminal device is used for description.

The apparatus includes a processing unit and a transceiver unit. The transceiver unit is configured to receive first information, where the first information includes N pieces of configuration information, the N pieces of configuration information are respectively used to configure N communication resources, and N is an integer greater than 1; the transceiver unit is further configured to receive second information, where the second information indicates M communication resources in the N communication resources, and M is a positive integer less than or equal to N; and the processing unit is configured to measure at least one of the M communication resources based on the first information and the second information.

In a possible embodiment of the fourth aspect, the N pieces of configuration information include k pieces of first configuration information and N-k pieces of second configuration information, and k communication resources configured by using the k pieces of configuration information are used for mobility management upon a communication resource change, where k is a positive integer.

In a possible embodiment of the fourth aspect, the N communication resources include a communication resource at a current moment and/or a communication resource at one or more future moments.

In a possible embodiment of the fourth aspect, the communication resource includes any one of the following: a cell indicated by a physical cell identifier PCI, a broadcast beam, a traffic beam, and a synchronization signal block SSB.

In a possible embodiment of the fourth aspect, the transceiver unit is further configured to send third information, where the third information indicates a result of the measurement.

In a possible embodiment of the fourth aspect, the second information includes indexes of the M communication resources.

In a possible embodiment of the fourth aspect, the second information includes effective time information corresponding to the N communication resources, and the effective time information and the current moment are used to determine the M pieces of configuration information; and/or the second information includes shift information corresponding to the N communication resources, and the shift information and the current moment are used to determine the M pieces of configuration information.

In a possible embodiment of the fourth aspect, each of the N communication resources corresponds to a first identifier and a second identifier. The first identifier is used to identify a resource index of each communication resource, and the second identifier is used to identify space domain information and/or polarization domain information of each communication resource. The M communication resources meet any one of the following: a first identifier corresponding to one of the M communication resources is the same as a first identifier corresponding to a target communication resource, and a second identifier corresponding to one of the M communication resources is different from a second identifier corresponding to the target communication resource, where the target communication resource is a communication resource other than the M communication resources in the N communication resources. Alternatively, a first identifier corresponding to any one of the M communication resources is different from the first identifier corresponding to the target communication resource.

In a possible embodiment of the fourth aspect, the transceiver unit is further configured to receive fourth information, where the fourth information indicates that P communication resources in the N communication resources are unavailable communication resources, and P is a positive integer.

In the fourth aspect of the embodiments, a module constituting the communication apparatus may be further configured to: perform the steps or operations performed in the possible embodiments of the first aspect, and achieve corresponding effects. For details, refer to the first aspect. Details are not described herein again.

A fifth aspect of the embodiments provides a communication apparatus. The apparatus is a first network device, a part of components (for example, a processor, a chip, or a chip system) in the first network device, or a logic module or software that can implement all or some functions of the first network device. In the fifth aspect and possible embodiments of the fifth aspect, an example in which the communication apparatus is a first network device is used for description.

The apparatus includes a processing unit and a transceiver unit. The processing unit is configured to determine first information and second information; the transceiver unit is configured to send the first information, where the first information includes N pieces of configuration information, the N pieces of configuration information are respectively used to configure N communication resources, and N is an integer greater than 1; and the transceiver unit is further configured to send the second information, where the second information indicates M communication resources in the N communication resources, and M is a positive integer less than or equal to N.

In a possible embodiment of the fifth aspect, the N pieces of configuration information include k pieces of first configuration information and N-k pieces of second configuration information, and k communication resources configured by using the k pieces of first configuration information are used for mobility management upon a communication resource change, where k is a positive integer.

In a possible embodiment of the fifth aspect, the N communication resources include a communication resource at a current moment and/or a communication resource at one or more future moments.

In a possible embodiment of the fifth aspect, the communication resource includes any one of the following: a cell indicated by a physical cell identifier PCI, a broadcast beam, a traffic beam, and a synchronization signal block SSB.

In a possible embodiment of the fifth aspect, the transceiver unit is further configured to receive third information, where the third information indicates a result of the measurement.

In a possible embodiment of the fifth aspect, the second information includes indexes of the M communication resources.

In a possible embodiment of the fifth aspect, the second information includes effective time information corresponding to the N communication resources, and the effective time information and the current moment are used to determine the M pieces of configuration information; and/or the second information includes shift information corresponding to the N communication resources, and the shift information and the current moment are used to determine the M pieces of configuration information.

In a possible embodiment of the fifth aspect, each of the N communication resources corresponds to a first identifier and a second identifier. The first identifier is used to identify a resource index of each communication resource, and the second identifier is used to identify space domain information and/or polarization domain information of each communication resource. The M communication resources meet any one of the following: a first identifier corresponding to one of the M communication resources is the same as a first identifier corresponding to a target communication resource, and a second identifier corresponding to one of the M communication resources is different from a second identifier corresponding to the target communication resource, where the target communication resource is a communication resource other than the M communication resources in the N communication resources. Alternatively, a first identifier corresponding to any one of the M communication resources is different from the first identifier corresponding to the target communication resource.

In a possible embodiment of the fifth aspect, the transceiver unit is further configured to send fourth information, where the fourth information indicates that P communication resources in the N communication resources are unavailable communication resources, and P is a positive integer.

In the fifth aspect of the embodiments, a module constituting the communication apparatus may be further configured to: perform the steps or operations performed in the possible embodiments of the second aspect, and achieve corresponding effects. For details, refer to the second aspect. Details are not described herein again.

A sixth aspect of the embodiments provides a communication apparatus. The apparatus is a second network device, a part of components (for example, a processor, a chip, or a chip system) in the second network device, or a logic module or software that can implement all or some functions of the second network device. In the sixth aspect and possible embodiments of the sixth aspect, an example in which the communication apparatus is a second network device is used for description.

The apparatus includes a processing unit and a transceiver unit. The transceiver unit is configured to receive first information, where the first information includes N pieces of configuration information, the N pieces of configuration information are respectively used to configure N communication resources, and N is an integer greater than 1; the transceiver unit is further configured to receive second information, where the second information indicates M communication resources in the N communication resources, and M is a positive integer less than or equal to N; and the processing unit is configured to determine the M communication resources based on the first information and the second information.

In a possible embodiment of the sixth aspect, the N pieces of configuration information include k pieces of first configuration information and N-k pieces of second configuration information, and k communication resources configured by using the k pieces of first configuration information are used for mobility management upon a communication resource change, where k is a positive integer.

In a possible embodiment of the sixth aspect, the N communication resources include a communication resource at a current moment and/or a communication resource at one or more future moments.

In a possible embodiment of the sixth aspect, the communication resource includes any one of the following: a cell indicated by a physical cell identifier PCI, a broadcast beam, a traffic beam, and a synchronization signal block SSB.

In a possible embodiment of the sixth aspect, the second information includes indexes of the M communication resources.

In a possible embodiment of the sixth aspect, the second information includes effective time information corresponding to the N communication resources, and the effective time information and the current moment are used to determine the M pieces of configuration information; and/or the second information includes shift information corresponding to the N communication resources, and the shift information and the current moment are used to determine the M pieces of configuration information.

In a possible embodiment of the sixth aspect, each of the N communication resources corresponds to a first identifier and a second identifier. The first identifier is used to identify a resource index of each communication resource, and the second identifier is used to identify space domain information and/or polarization domain information of each communication resource. The M communication resources meet any one of the following: a first identifier corresponding to one of the M communication resources is the same as a first identifier corresponding to a target communication resource, and a second identifier corresponding to one of the M communication resources is different from a second identifier corresponding to the target communication resource, where the target communication resource is a communication resource other than the M communication resources in the N communication resources. Alternatively, a first identifier corresponding to any one of the M communication resources is different from the first identifier corresponding to the target communication resource.

In a possible embodiment of the sixth aspect, the transceiver unit is further configured to receive fourth information, where the fourth information indicates that P communication resources in the N communication resources are unavailable communication resources, and P is a positive integer.

In the sixth aspect of the embodiments, a module constituting the communication apparatus may be further configured to: perform the steps or operations performed in the possible embodiments of the third aspect, and achieve corresponding effects. For details, refer to the third aspect. Details are not described herein again.

A seventh aspect of the embodiments provides a communication apparatus, including at least one processor. The at least one processor is coupled to a memory, the memory is configured to store a program or instructions, and the at least one processor is configured to execute the program or the instructions, to cause the apparatus to implement the method in any one of the first aspect or the possible embodiments of the first aspect.

An eighth aspect of the embodiments provides a communication apparatus, including at least one processor. The at least one processor is coupled to a memory, the memory is configured to store a program or instructions, and the at least one processor is configured to execute the program or the instructions, to cause the apparatus to implement the method in any one of the second aspect or the possible embodiments of the second aspect.

A ninth aspect of the embodiments provides a communication apparatus, including at least one processor. The at least one processor is coupled to a memory, the memory is configured to store a program or instructions, and the at least one processor is configured to execute the program or the instructions, to cause the apparatus to implement the method in any one of the third aspect or the possible embodiments of the third aspect.

A tenth aspect of embodiments of the embodiments provides a communication apparatus, including at least one logic circuit and an input/output interface. The logic circuit is configured to perform the method according to any one of the first aspect or the possible embodiments of the first aspect.

An eleventh aspect of embodiments of the embodiments provides a communication apparatus, including at least one logic circuit and an input/output interface. The logic circuit is configured to perform the method according to any one of the second aspect or the possible embodiments of the second aspect.

A twelfth aspect of embodiments of the embodiments provides a communication apparatus, including at least one logic circuit and an input/output interface. The logic circuit is configured to perform the method according to any one of the third aspect or the possible embodiments of the third aspect.

A thirteenth aspect of embodiments of the embodiments provides a communication system. The communication system includes at least two of the communication apparatus in the fourth aspect, the communication apparatus in the fifth aspect, and the communication apparatus in the sixth aspect. Alternatively, the communication system includes at least two of the communication apparatus in the seventh aspect, the communication apparatus in the eighth aspect, and the communication apparatus in the ninth aspect. Alternatively, the communication system includes at least two of the communication apparatus in the tenth aspect, the communication apparatus in the eleventh aspect, and the communication apparatus in the twelfth aspect.

A fourteenth aspect of embodiments of the embodiments provides a non-transitory computer-readable storage medium storing one or more computer-executable instructions. When the computer-executable instructions are executed by a processor, the processor performs the method according to any possible embodiment of any one of the first aspect to the third aspect.

A fifteenth aspect of embodiments of the embodiments provides a computer program product (or referred to as a computer program) storing one or more computer-executable instructions. When the computer program product is executed by a processor, the processor performs the method according to any possible embodiment of any one of the first aspect to the third aspect.

A sixteenth aspect of embodiments of the embodiments provides a chip system. The chip system includes at least one processor, configured to support a communication apparatus in implementing the method according to any possible embodiment of any one of the first aspect to the third aspect.

In a possible embodiment, the chip system may further include a memory. The memory is configured to store program instructions and data that may be used by the communication apparatus. The chip system may include a chip, or may include a chip and another discrete component. Optionally, the chip system further includes an interface circuit, and the interface circuit provides program instructions and/or data for the at least one processor.

For effects brought by any embodiment in the fourth aspect to the sixteenth aspect, refer to effects brought by different embodiments in the first aspect to the third aspect. Details are not described herein again.

It can be understood from the foregoing solutions that the solutions provided in the embodiments have the following beneficial effects: N pieces of configuration information included in first information received by a terminal device are respectively used to configure N communication resources, and second information received by the terminal device indicates M communication resources in the N communication resources, so that the terminal device can determine the M communication resources based on the first information and the second information, and the terminal device can measure at least one of the M communication resources. Therefore, when a network device moves and a communication resource indicated by the network device changes, the network device can dynamically activate (enable, turn on, or the like) the M communication resources in the N communication resources by using the second information, so that the network device may not reconfigure a changed communication resource, reducing signaling overheads and implementation complexity, and improving communication efficiency.

### BRIEF DESCRIPTION OF DRAWINGS

FIG. 1 is a diagram of a communication system according to the embodiments;

FIG. 2a is a diagram of a communication system according to the embodiments;

FIG. 2b is a diagram of satellite communication according to the embodiments;

FIG. 3a is a diagram of a communication signal coverage area according to the embodiments;

FIG. 3b is a diagram of a communication signal coverage area according to the embodiments;

FIG. 3c is a diagram of a communication signal coverage area according to the embodiments;

FIG. 3d is a diagram of a communication signal coverage area according to the embodiments;

FIG. 4 is a diagram of a communication method according to the embodiments;

FIG. 5a is a diagram of a communication signal coverage area according to the embodiments;

FIG. 5b is a diagram of a communication signal coverage area according to the embodiments;

FIG. 5c is a diagram of a communication signal coverage area according to the embodiments;

FIG. 6a is a diagram of a space domain/polarization domain of a communication signal according to the embodiments;

FIG. 6b is a diagram of a space domain/polarization domain of a communication signal according to the embodiments;

FIG. 6c is a diagram of a space domain/polarization domain of a communication signal according to the embodiments;

FIG. 7a is a diagram of a communication signal coverage area according to the embodiments;

FIG. 7b is a diagram of a communication signal coverage area according to the embodiments;

FIG. 7c is a diagram of a communication signal coverage area according to the embodiments;

FIG. 8a is a diagram of a communication signal coverage area according to the embodiments;

FIG. 8b is a diagram of a communication signal coverage area according to the embodiments;

FIG. 8c is a diagram of a communication signal coverage area according to the embodiments;

FIG. 9a is a diagram of a communication signal coverage area according to the embodiments;

FIG. 9b is a diagram of a communication signal coverage area according to the embodiments;

FIG. 9c is a diagram of a communication signal coverage area according to the embodiments;

FIG. 10 is a diagram of a communication apparatus according to the embodiments;

FIG. 11 is a diagram of a communication apparatus according to the embodiments;

FIG. 12 is a diagram of a communication apparatus according to the embodiments; and

FIG. 13 is a diagram of a communication apparatus according to the embodiments.

### DETAILED DESCRIPTION OF EMBODIMENTS

First, some terms in embodiments are explained and described, to facilitate understanding of a person skilled in the art.

(1) Terminal device: the terminal device may be a wireless terminal device that can receive scheduling and indication information of a network device. The wireless terminal device may be a device that provides voice and/or data connectivity for a user, a handheld device with a wireless connection function, or another processing device connected to a wireless modem.

The terminal device may be various communication kits (the kit may include, for example, an antenna, a power supply kit, a cable, and a Wi-Fi module) having a wireless communication function. The terminal device may alternatively be a communication module having a satellite communication function, a satellite phone or a component thereof, or a very small aperture terminal (VSAT). The terminal device may be a mobile terminal device, for example, a mobile phone (or referred to as a “cellular” phone or a mobile phone), a computer, or a data card. For example, the terminal device may be a portable, pocket-sized, handheld, computer built-in, or vehicle-mounted mobile apparatus, which exchanges voice and/or data with a radio access network. For example, the terminal device is a device such as a personal communication service (PCS) phone, a cordless phone, a session initiation protocol (SIP) phone, a wireless local loop (WLL) station, a personal digital assistant (PDA), a tablet computer (Pad), or a computer having a wireless transceiver function. The wireless terminal device may also be referred to as a system, a subscriber unit, a subscriber station, a mobile console, a mobile station (MS), a remote station, an access point (AP), a remote terminal device, an access terminal device, a user terminal device, a user agent, a subscriber station (SS), customer premises equipment (CPE), a terminal, user equipment (UE), a mobile terminal (MT), an uncrewed aerial vehicle, or the like. The terminal device may alternatively be a wearable device and a terminal device in a next generation communication system, for example, a terminal device in a 6G communication system or a terminal device in a future evolved public land mobile network (PLMN). In another embodiment, the terminal device in the embodiments may alternatively be a chip, a modem, a system on a chip (SoC), or a communication platform that may include a radio frequency (RF) part or the like, which are responsible for a related communication function in the device.

(2) Network device: the network device may be a device in a wireless network. For example, the network device may be a radio access network (RAN) node (or device), or may be referred to as a base station, through which the terminal device accesses the wireless network. Currently, some examples of the RAN device are: a next-generation base station in a future communication system, a transmission reception point (TRP), an evolved NodeB (eNB), a radio network controller (RNC), a NodeB (NB), a base station controller (BSC), a base transceiver station (BTS), a home base station (for example, a home evolved NodeB or a home NodeB, HNB), a baseband unit (BBU), a wireless fidelity (Wi-Fi) access point (AP), or the like. In addition, in a network structure, the network device may include a central unit (CU) node, a distributed unit (DU) node, or a RAN device including a CU node and a DU node.

In some embodiments, the network device may further include a satellite, an airplane, an uncrewed aerial vehicle, a ground station device connected to a satellite, an airplane, an uncrewed aerial vehicle, and the like.

The network device can send configuration information (for example, carried in a scheduling message and/or an indication message) to the terminal device. The terminal device further performs network configuration based on the configuration information, so that the network configurations of the network device and the terminal device are aligned. Alternatively, through a network configuration preset in the network device and a network configuration preset in the terminal device, the network configurations of the network device and the terminal device are aligned. For example, “alignment” means that when there is an interaction message between the network device and the terminal device, the network device and the terminal device have a consistent understanding of a carrier frequency for sending and receiving the interaction message, determining of a type of the interaction message, a meaning of field information carried in the interaction message, or another configuration of the interaction message.

In addition, in another possible case, the network device may be another apparatus providing a wireless communication function for the terminal device. A technology and a device form that are used by the network device are not limited. For ease of description, this is not limited.

The network device may further include a core network device. The core network device includes, for example, an access and mobility management function (AMF), a user plane function (UPF), or a session management function (SMF).

In embodiments, an apparatus configured to implement a function of a network device may be the network device, or may be an apparatus that can support the network device in implementing the function, for example, a chip system. The apparatus may be installed in the network device. In the solutions provided in embodiments, an example in which the apparatus configured to implement the function of the network device is a network device is used for describing the solutions provided in embodiments.

(3) Configuration and preconfiguration: in the embodiments, both the configuration and the preconfiguration are used. The configuration means that a network device sends configuration information of some parameters or parameter values to a terminal device by using a message or signaling, so that the terminal device determines a communication parameter or a transmission resource based on the values or the information. Similar to the configuration, the preconfiguration may be parameter information or a parameter value negotiated by a network device and a terminal device in advance, or may be parameter information or a parameter value used by a network device or a terminal device as specified in a standard protocol, or may be parameter information or a parameter value pre-stored in a network device or a terminal device. This is not limited.

Further, these values and parameters may be changed or updated.

(4) Terms “system” and “network” in embodiments may be used interchangeably. “At least one” means one or more, and “multiple” means two or more. The term “and/or” describes an association relationship of associated objects, and indicates that three relationships may exist. For example, A and/or B may indicate the following three cases: only A exists, both A and B exist, and only B exists, where A and B may be singular or plural. The character “/” generally indicates an “or” relationship between the associated objects. “At least one of the following items (pieces)” or a similar expression thereof refers to any combination of these items, including any combination of singular items (pieces) or plural items (pieces). For example, “at least one of A, B, and C” includes A, B, C, AB, AC, BC, or ABC. In addition, unless otherwise specified, ordinal numbers such as “first” and “second” in embodiments are used to distinguish between multiple objects, and are not used to limit a sequence, a time sequence, priorities, or importance of the multiple objects.

The embodiments may be applied to a long term evolution (LTE) system, a new radio (NR) system, or a new radio vehicle to everything (NR vehicle to everything, NR V2X) system; and may also be applied to a system of hybrid networking of LTE and 5G, a device-to-device (D2D) communication system, a machine to machine (M2M) communication system, Internet of Things (IoT), an uncrewed aerial vehicle communication system, a communication system that supports multiple wireless technologies, for example, an LTE technology and an NR technology, or a non-terrestrial communication system, for example, a satellite communication system, or a high-altitude communication platform. In addition, optionally, the communication system may also be applicable to a narrow band-Internet of Things (NB-IoT) system, an enhanced data rate for GSM evolution (EDGE) system, a wideband code division multiple access (WCDMA) system, a code division multiple access 2000 (CDMA 2000) system, a time division-synchronization code division multiple access (TD-SCDMA) system, a future-oriented communication technology, or another communication system. The communication system includes a network device and a terminal device. The network device serves as a configuration information sending entity, and the terminal device serves as a configuration information receiving entity. For example, in the communication system, an entity sends configuration information to another entity, and sends data to the another entity or receives data sent by the another entity. The another entity receives the configuration information, and sends data to the configuration information sending entity based on the configuration information or receives data sent by the configuration information sending entity. The embodiments may be applied to a terminal device in a connected state or an active (active) state, or may be applied to a terminal device in a non-connected (inactive) state or an idle state.

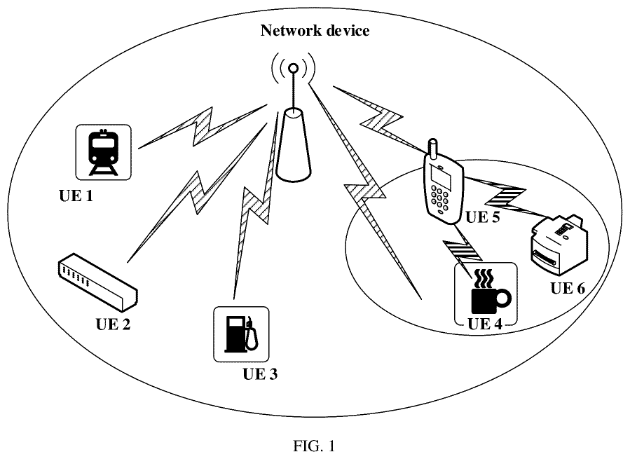

FIG. 1 is a diagram of an application scenario according to an embodiment. As shown in FIG. 1, a configuration information sending entity may be a network device, and a configuration information receiving entity may be UE 1 to UE 6. In this case, a base station and the UE 1 to the UE 6 form a communication system. In the communication system, the UE 1 to the UE 6 may send uplink data to the network device, and the network device may receive the uplink data sent by the UE 1 to the UE 6. In addition, the network device may send configuration information to the UE 1 to the UE 6.

It may be noted that the solutions in embodiments are applicable to a communication system that integrates terrestrial communication and satellite communication. The communication system may also be referred to as a non-terrestrial network (NTN) communication system. The terrestrial communication system may be, for example, a long term evolution (LTE) system, a universal mobile telecommunications system (UMTS), a 5G communication system or a new radio (NR) system, or a communication system developed in a next phase of a 5G communication system. This is not limited herein.

Compared with a conventional mobile communication system, satellite communication has wider coverage, supports independence of a transmission link and communication costs and a transmission distance, and has advantages such as overcoming natural geographical obstacles like oceans, deserts, and mountains. To overcome disadvantages of a conventional communication network, satellite communication may serve as an effective supplement to the conventional network. It is generally considered that a non-terrestrial communication network (NTN) has channel characteristics different from that of terrestrial communication, such as large transmission delay and large Doppler frequency offset. For example, a round-trip delay of GEO satellite communication is 238 to 270 milliseconds (ms). A round-trip delay of LEO satellite communication is 8 ms to 20 ms. Based on different orbit heights, satellite communication systems may be classified into the following three types: a high earth orbit (GEO) satellite communication system, also referred to as a geostationary earth orbit satellite system, a medium earth orbit (MEO) satellite communication system, and a low earth orbit (LEO) satellite communication system.

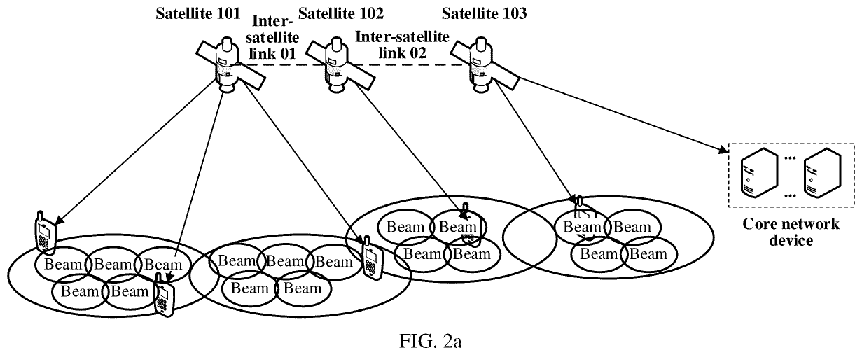

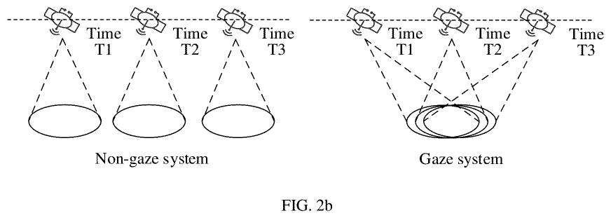

As an embodiment example, FIG. 2a is an embodiment example of a satellite communication system. In FIG. 2a, the satellite communication system includes a satellite 101, a satellite 102, and a satellite 103. Each satellite may provide a communication service, a navigation service, a positioning service, and the like for a terminal device through multiple beams. A satellite in this scenario is an LEO satellite, and the satellite 103 is connected to a ground station device. The satellite uses multiple beams to cover a serving area, and different beams may be used for communication in one or more manners of time division, frequency division, and space division. The satellite performs wireless communication with the terminal device by using a broadcast communication signal, a navigation signal, and the like. The satellite may perform wireless communication with a ground station device. The satellite mentioned in this embodiment may be a satellite base station, may include an orbit receiver or a repeater configured to relay information, or may be a network side device mounted on the satellite.

Optionally, the satellite communication system includes a transparent transmission satellite architecture and a non-transparent transmission satellite architecture. Transparent transmission is also referred to as bent-pipe forwarding transmission. For example, only processes such as frequency conversion and signal amplification are performed on a signal on a satellite, and the satellite is transparent to the signal as if the satellite does not exist. Non-transparent transmission is also referred to as regenerative (on-satellite access/processing) transmission. For example, the satellite has some or all of functions of a base station. For example, the satellite 101 and the satellite 102 in FIG. 2a are of the non-transparent transmission satellite architecture, and the satellite 103 is of the transparent transmission satellite architecture.

It may be noted that the base station of the NTN and the base station of the terrestrial network may be interconnected via a common core network. Alternatively, assistance and interconnection with higher timeliness may be implemented by using an interface defined between base stations. In NR, an interface between base stations is referred to as an Xn interface, and an interface between a base station and a core network is referred to as an NG interface. In a converged network, both an NTN node and a ground node may implement interworking and collaboration through the foregoing interfaces.

In a possible embodiment, the satellite may work in an earth-fixed system, a quasi-earth fixed system, or a satellite-fixed system. The earth-fixed mode or the quasi-earth fixed system may also be referred to as a gaze system, and the satellite-fixed system may also be referred to as a non-gaze system. For example, in a non-gaze system shown in FIG. 2b, within a period of time (for example, time T1, T2, and T3), coverage of a satellite beam moves with the satellite. In a gaze system shown in FIG. 2b, within a period of time (for example, time T1, T2, and T3), the satellite dynamically adjusts a beam direction, so that the beam approximately covers a same area on the ground.

The foregoing content describes multiple wireless communication scenarios in the embodiments. It should be understood that the foregoing content is merely an example of scenarios to which the embodiments may be applied. The embodiments may be further applied to another application scenario. This is not limited herein. The following describes a wireless communication process in the embodiments.

In an embodiment example, a beam hopping communication technology may be used in a communication process in the embodiments.

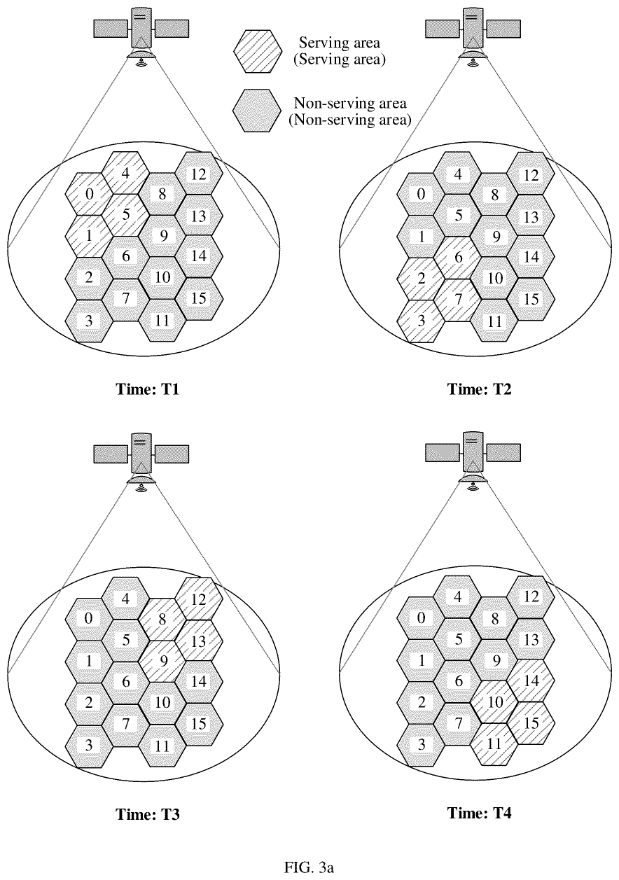

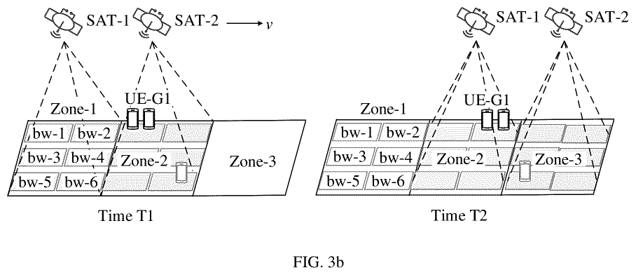

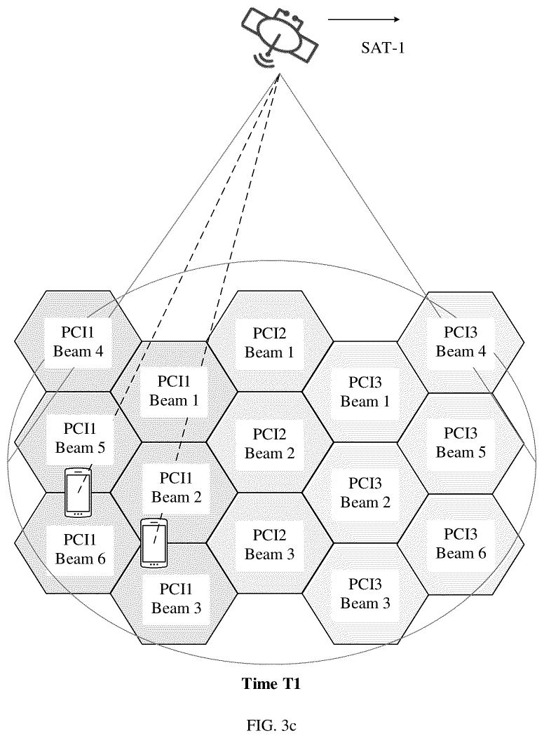

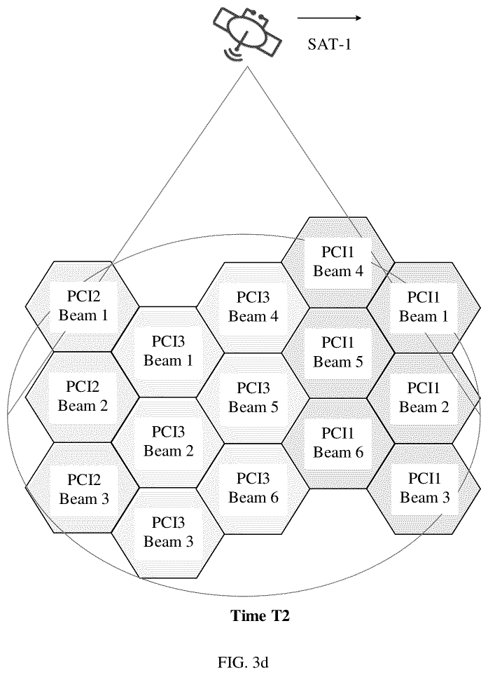

Generally, a single satellite has extremely wide coverage, which may reach thousands or even tens of thousands of kilometers, and a single beam has minimum coverage of dozens or even thousands of meters. Therefore, to support wide area coverage, hundreds or even thousands of beams may be configured for a single satellite. This poses a great challenge to load of the satellite (for example, an LEO satellite). To alleviate a contradiction between low load and wide coverage of a single satellite, a beam hopping satellite communication system emerges. For example, in the beam hopping satellite system, only a few beams (for example, dozens of beams) are configured for a single satellite, and the beams serve all the coverage areas of the single satellite in a time division manner. As shown in FIG. 3a, it is assumed that a satellite can form only four beams at a same moment. At a moment T1, four beams 0, 1, 4, and 5 are used to cover an area (for example, a beam position) corresponding to the satellite. At a moment T2, four beams 2, 3, 6, and 7 are used to cover an area corresponding to the satellite. At a moment T3, four beams 8, 9, 12, and 13 are used to cover an area corresponding to the satellite. At a moment T4, four beams 10, 11, 14, and 15 are used to cover an area corresponding to the satellite. Therefore, by using the beam hopping communication technology, the satellite serves all areas (for example, areas corresponding to 16 beams) covered by the single satellite at T1, T2, T3, and T4 in a time division manner.

In another embodiment example, a communication process in the embodiments may relate to mobility management.

FIG. 3a is used as an example. In the beam hopping satellite communication system, movement of the satellite node causes group handover (group handover may occur on terminal devices in a connected state) or group reselection (group reselection may occur on terminal devices in an idle state) of users in a beam position in a zone.

Group handover is used as an example. As shown in FIG. 3b, a communication zone of a satellite may be represented as a zone in the figure. Each zone includes one or more beam positions (denoted as bw), and the beam position may be understood as a fixed geographical area on the earth sphere. In the figure, an example in which each zone includes six beam positions is used for description. One or more terminal devices in a single beam position in a zone 2 may be denoted as a UE cluster (UE-G1), for example, UE-G1 includes multiple terminal devices. At a moment T1 (Time T1), UE-G1 is served by one or more beams of a satellite 2 (SAT-2). At a moment T2 (Time T2), movement of the satellite SAT-2 causes service unavailability in this beam position, and one or more beams of a satellite 1 (SAT-1) take over to serve UE-G1. Therefore, group handover occurs on the UE cluster UE-G1. In addition, because the satellite moves at a high speed (for example, the satellite moves at a speed of about 7.5 km/s), group handover occurs sequentially at a frequency of around seconds to dozens of seconds. In other words, in a beam hopping LEO satellite network, group handover triggered by movement of a network device becomes normal. From Time T1 to Time T2, the UE-G1 group in the serving area of SAT-2 triggers neighboring satellite broadcast beam measurement (for example, SSB-based measurement timing configuration (SMTC) measurement) and performs handover/reselection.

In addition, the movement of the network node may also cause a dynamic change of a neighbor relationship. From Time T1 to T2, the broadcast beam in the satellite/base station changes. As shown in FIG. 3c, at a moment T1, cell arrangement (from left to right) in SAT-1 is a cell indicated by PCI1, a cell indicated by PCI2, and a cell indicated by PCI3 respectively. Beam coverage (for example, a quantity of beams and/or a beam shape) in different PCIs may be different. As shown in FIG. 3d, at a moment T2, because the satellite cannot keep gazing/serving the area corresponding to the cell originally indicated by PCI1, the cell indicated by PCI1 may serve an area that the satellite newly enters (for example, an area on the right of SAT-1). In this case, the cell arrangement (from left to right) in SAT-1 changes to PCI2, PCI3, and PCI1. It is easy to see that the dynamic change of cells within the coverage of the satellite causes a changed neighboring cell relationship within the satellite or between different satellites. Further, a neighboring cell relationship between different satellites also changes accordingly.

It may be noted that in an implementation process of NR/NTN mobility management, the mobility management can include cell handover, cell reselection, and the like.

A cell handover process is used as an example. A handover process of a terrestrial network can include the following steps or operations.

1. Cell handover measurement: generally, a network device (for example, the network device is a base station) delivers measurement configurations corresponding to multiple cells (including a serving cell and a neighboring cell) to a terminal device (for example, the terminal device is UE), and the UE measures cell signal quality (for example, received signal strength indicator (RSSI), reference signal received power (RSRP), and reference signal received quality (RSRQ)) based on the measurement configurations.

2. Measurement result reporting: the UE reports a measurement result to the base station. The reporting may be periodic reporting or event-triggered reporting. In the event-triggered reporting, a reporting condition may be configured as that signal quality of a serving cell is less than a threshold 1 and/or signal quality of a neighboring cell is greater than a threshold 2.

3. Handover decision: the base station selects an appropriate neighboring cell based on the reported result, and exchanges context information related to user handover, information about admission control, reserved resources, and the like.

4. Handover execution: the UE receives handover-related control information from the serving cell, and completes an access procedure in a new cell.

It may be understood that a random access preamble required by the UE during handover is a dedicated random access preamble, and may be different from a contention-based random access preamble during initial access. In addition, supported random access channel (RACH) time domain periodicity configurations during handover include Oct. 20, 1940/80/160 ms, which may be the same as an RACH periodicity configuration during initial access.

A cell reselection process is used as an example. A network device (for example, the network device is a base station) may deliver parameters such as a measurement configuration related to a neighboring cell to a terminal device (for example, the terminal device is UE) in a broadcast manner. The UE compares a measurement value (for example, RSRP and RSRQ) of the UE with a parameter (for example, a reselection threshold) delivered by the network, and autonomously reselects a target neighboring cell after a condition is met. It may be noted that, because a near-far effect in an NTN is not definite, efficiency of handover/reselection triggered by signal quality alone is low. Therefore, a location-assisted handover/reselection enhancement technology is considered for the NR/NTN. For example, mobility management in the NTN network is implemented based on multiple manners such as time/timer, UE location information (for example, a distance between the UE and a reference point of a source cell is greater than a threshold 1, and a distance between the UE and a reference point of a target cell is less than a threshold 2) and timer, and a combination of location and signal quality.

In another embodiment example, a communication process in the embodiments may relate to neighboring cell relationship management of a network device.

In a terrestrial LTE/NR network, a network device (for example, a gNB) can use an automatic neighbor relation (ANR) function to manage a neighboring cell relationship. For example, ANR includes a neighboring cell addition function (adding a new neighboring cell) and a neighboring cell removal function (removing an existing neighboring cell). The neighboring cell addition function is implemented by exchanging a measurement report between the gNB and a terminal device (for example, the terminal device is UE), and a neighbor cell relation table (NCRT) is maintained on the gNB side to record a neighboring cell attribute. Neighboring cell attributes supported by an NR protocol include No Remove, No HO, and No X2. No Remove indicates whether a current neighboring cell can be removed, No HO indicates whether a current neighboring cell can be used for handover, and No X2 indicates whether an X2 interface can be set up in a current neighboring cell.

Using the communication systems shown in FIG. 1 and FIG. 2a as an example, a network device (for example, a ground base station or a satellite) may send a broadcast signal, and a communication resource may be configured by using the broadcast signal (for example, the communication resource may include a communication resource of the network device and a communication resource of a neighboring network device that possibly exists), so that a receiver of the broadcast signal can determine a corresponding communication resource based on the information. For example, when the receiver of the information is a terminal device, the terminal device can obtain a network service based on the communication resource.

Generally, an example in which the network device is a ground base station is used. Because the ground base station and another neighboring ground base station may be stationary at certain places on the ground, communication resources indicated by broadcast signals sent by the ground base station at different moments may remain unchanged.

However, in a future communication network, a network device may no longer be stationary at a place on the ground. For example, the network device may be a device like the satellite in FIG. 2a, an airplane, or an uncrewed aerial vehicle. In this case, because the network device moves at a high speed, a communication resource of the network device or a neighboring network device may change frequently. Consequently, once the communication resource of the network device and/or the communication resource of the neighboring network device change, a changed communication resource may be reconfigured by using a broadcast signal, causing high signaling overheads and implementation complexity.

For example, the communication resource is a cell indicated by a PCI. In an implementation process of mobility management corresponding to the foregoing beam hopping communication technology, in an NTN scenario (for example, in a gaze system), cell handover is accompanied with frequent dynamic changes of a PCI set on a network side, causing high signaling overheads and implementation complexity.

For another example, the communication resource is a cell indicated by a PCI. In an implementation process of neighboring cell relationship management of the network device, as the network device (for example, a satellite) moves at a high speed, a neighboring cell relationship of the satellite is characterized by dynamic changes. Simply reusing a neighboring cell relationship maintenance mechanism of LTE/NR results in frequent addition to and removal from a neighbor cell relation table based on ANR. Signaling overheads are high.

Therefore, how to reduce signaling overheads is an urgent problem to be resolved.

To resolve the foregoing problem, the embodiments provides a communication method and a communication apparatus. The following further provides descriptions with reference to more accompanying drawings.

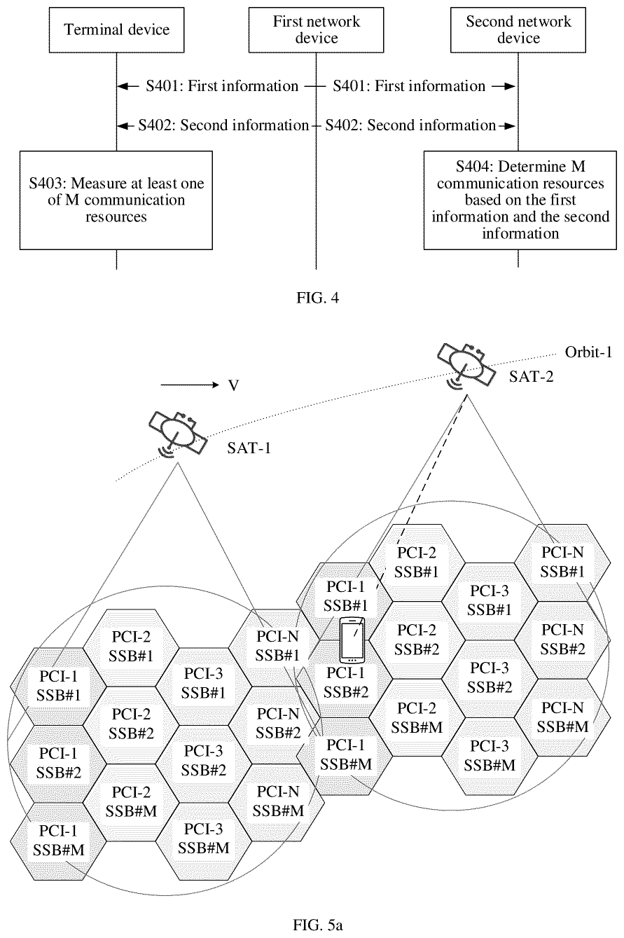

FIG. 4 is a diagram of a communication method according to the embodiments.

It may be noted that in FIG. 4, the method is illustrated by using an example in which a terminal device, a first network device, and a second network device serve as execution bodies of the interaction illustration. However, the execution bodies of the interaction illustration are not limited. For example, in FIG. 4 and the corresponding embodiment, S401 to S403 are performed by the terminal device, or may be performed by a chip, a chip system, or a processor that supports the terminal device in implementing the method, or may be a logic module or software that can implement all or a part of functions of the terminal device. The first network device in S401 to S402 in FIG. 4 and the corresponding embodiment may also be replaced with a chip, a chip system, or a processor that supports the first network device in implementing the method, or may be replaced with a logic module or software that can implement all or a part of functions of the first network device. The second network device in S401, S402, and S404 in FIG. 4 and the corresponding embodiment may also be replaced with a chip, a chip system, or a processor that supports the second network device in implementing the method, or may be replaced with a logic module or software that can implement all or a part of functions of the second network device.

S401: a first network device sends first information, and correspondingly, a terminal device receives the first information. A second network device may also receive the first information. The first information includes N pieces of configuration information, the N pieces of configuration information are respectively used to configure N communication resources, and N is an integer greater than 1.

It may be understood that a network device (for example, the first network device) in the embodiment shown in FIG. 4 may be a network device with mobility in an NTN communication system, for example, a satellite, an airplane, or an uncrewed aerial vehicle. The second network device may be a base station fixed on the earth surface, or may be a network device with mobility. This is not limited herein.

In step or operation S401, the N communication resources configured by using the N pieces of configuration information included in the first information sent by the first network device may include a communication resource of the first network device, or may include a communication resource of a neighboring network device of the first network device (for example, the second network device). This is not limited herein.

It may be understood that in step or operation S401, when the N communication resources configured by using the N pieces of configuration information in the first information include a communication resource of a neighboring network device of the first network device, before the first network device sends the first information in step or operation S401, the first network device may receive one or more pieces of configuration information of the neighboring network device (the one or more pieces of configuration information is used to configure the communication resource of the neighboring network device), so that the first network device determines the N pieces of configuration information based on the one or more pieces of configuration information.

In a possible embodiment, in step or operation S401, the N pieces of configuration information include k pieces of first configuration information and N-k pieces of second configuration information, and k communication resources configured by using the k pieces of first configuration information are used for mobility management upon a communication resource change, where k is a positive integer. In other words, the N communication resources configured by using the N pieces of configuration information include k first communication resources configured by using the k pieces of first configuration information and N-k second communication resources configured by using the N-k pieces of first configuration information. Before the communication resource changes, a quantity of communication resources carried by a satellite in the NTN communication system is equal to a quantity of second communication resources, and k is a positive integer. For example, the N pieces of configuration information included in the first information sent by the network device include the k pieces of configuration information, and the k communication resources that are configured are used for mobility management upon a communication resource change, so that a receiver of the first information (for example, the terminal device or the second network device) can determine, when the communication resource of the network device and/or the communication resource of the neighboring network device change, that one or more of the k communication resources are available communication resources.

Optionally, that the k communication resources are used for mobility management upon a communication resource change may be understood as that, before the communication resource of the network device and/or the communication resource of the neighboring network device change, the quantity of communication resources carried by the satellite in the NTN communication system is equal to the quantity of second communication resources (for example, N-k). When the communication resource of the network device and/or the communication resource of the neighboring network device change, one or more resources of the k communication resources are added to the communication resources carried by the satellite in the NTN communication system, and the second communication resources originally carried by the satellite in the NTN communication system may remain unchanged, or one or more of the N-k second communication resources may be removed. This is not limited herein. Correspondingly, that the k communication resources are used for mobility management upon a communication resource change may be expressed as follows: one or more of the k communication resources are communication resources used for mobility management in a signal coverage area, in a movement direction of the network device, the network device is to enter (or a signal coverage area the network device has entered).

Optionally, second information is used to determine M communication resources in the N communication resources, and the k communication resources in the N communication resources are used for mobility management upon a communication resource change. For example, before the communication resource of the network device and/or the communication resource of the neighboring network device change, the M communication resources indicated by the second information may not include one or more of the k communication resources. After the communication resource of the network device and/or the communication resource of the neighboring network device change, the M communication resources indicated by the second information may include one or more of the k communication resources.

In a possible embodiment, in step or operation S401, the N communication resources include a communication resource at a current moment and/or a communication resource at one or more future moments. For example, in the N pieces of configuration information included in the first information sent by the network device, the N communication resources configured by using the N pieces of configuration information include the communication resource at the current moment and/or the communication resource at one or more future moments, so that a receiver of the first information (for example, the terminal device or the second network device) can determine the communication resource at the current moment and/or the communication resource at one or more future moments based on the first information.

In a possible embodiment, the communication resource includes any one of the following: a cell indicated by a physical cell identifier (PCI), a broadcast beam, a traffic beam, and a synchronization signal block (synchronization signal/physical broadcast channel block, SS/PBCH block, SS/PBCH block, or SSB). For example, the communication resource configured by using the first information sent by the network device may include any one of the foregoing, so that the foregoing solution can be applied to a process of configuring and dynamically activating multiple types of communication resources.

Optionally, the first information is carried in at least one of a system information block (SIB) 2, a SIB3, and a SIB4. Alternatively, the first information is carried in other signaling/another message. This is not limited herein.

S402: the first network device sends the second information, and correspondingly, the terminal device receives the second information. The second network device may also receive the second information. The second information indicates M communication resources of the N communication resources, and M is a positive integer less than or equal to N.

In a possible embodiment, in step or operation S402, the second information sent by the first network device includes indexes of the M communication resources. For example, the second information used to determine the M communication resources may include the indexes of the M communication resources, so that a receiver of the second information can determine the M communication resources in an explicit indication manner.

In a possible embodiment, in step or operation S402, the second information sent by the first network device includes effective time information corresponding to the N communication resources, and the effective time information and the current moment are used to determine the M pieces of configuration information; and/or in step or operation S402, the second information sent by the first network device includes shift information corresponding to the N communication resources, and the shift information and the current moment are used to determine the M pieces of configuration information. For example, the second information used to determine the M communication resources may include the effective time information and/or the shift information corresponding to the N communication resources, so that a receiver of the second information can determine the M communication resources in an implicit indication manner.

In a possible embodiment, each of the N communication resources corresponds to a first identifier and a second identifier. The first identifier is used to identify a resource index of each communication resource, and the second identifier is used to identify space domain information and/or polarization domain information of each communication resource. The M communication resources meet any one of the following: a first identifier corresponding to one of the M communication resources is the same as a first identifier corresponding to a target communication resource, and a second identifier corresponding to one of the M communication resources is different from a second identifier corresponding to the target communication resource, where the target communication resource is a communication resource other than the M communication resources in the N communication resources. Alternatively, a first identifier corresponding to any one of the M communication resources is different from the first identifier corresponding to the target communication resource.

Optionally, when the communication resource is a cell indicated by a PCI, the first identifier may be the PCI, and the second identifier may be a space domain identifier and/or a polarization domain identifier corresponding to the cell indicated by the PCI.

Optionally, when the communication resource is an SSB, the first identifier may be an SSB index, and the second identifier may be a space domain identifier and/or a polarization domain identifier corresponding to the SSB.

Optionally, when the communication resource is a beam (for example, a broadcast beam or a traffic beam), the first identifier may be a beam index, and the second identifier may be a space domain identifier and/or a polarization domain identifier corresponding to the beam.

For example, in the N communication resources configured by using the first information sent by the network device, when resource indexes of different communication resources are the same, the different communication resources may have different space domains and/or different polarization domains, or different communication resources may have different resource indexes, to provide multiple implementations in which the network device configures the N communication resources, improving flexibility of implementing the solution.

Optionally, the second information is carried in an XnAP (an XnAP message is used to carry signaling between different access network devices), a medium access control control element (MAC CE), downlink control information (DCI), a SIBx (a value of x ranges from 1 to 19), a radio resource control (RRC) configuration message, an RRC reconfiguration message, or the like. Alternatively, the second information is carried in other signaling/another message. This is not limited herein.

S403: the terminal device measures at least one of the M communication resources to assist in mobility management of the NTN communication system. After the terminal device determines the M communication resources based on the first information received in step or operation S401 and the second information received in step or operation S402, the terminal device measures at least one of the M communication resources in step or operation S403.

In a possible embodiment, in step or operation S403, the mobility management includes at least one of cell handover, cell reselection, registration area update, and tracking area update. For example, after the terminal device determines the M communication resources based on the first information and the second information, the terminal device can measure at least one of the M communication resources, to assist the NTN communication system in performing at least one of the foregoing mobility management, to implement management on at least one of the following aspects: terminal device location information, security, and service continuity.

In a possible embodiment, the method further includes: the terminal device sends third information, where the third information indicates a result of the measurement. For example, after the terminal device measures at least one of the M communication resources, the terminal device may send the third information indicating measurement information of the measurement process, so that the network device determines, based on the third information, communication quality of the terminal device on the at least one communication resource, and may subsequently schedule the terminal device based on the third information.

Optionally, the third information may include a measurement report of at least one of the M communication resources, or the third information may include information in a measurement report of at least one of the M communication resources.

In a possible embodiment, in the method shown in FIG. 4, the method further includes: the first network device sends fourth information, and correspondingly, the terminal device receives the fourth information, where the fourth information indicates that P communication resources in the N communication resources are unavailable communication resources, and P is a positive integer. For example, when the network device moves and the communication resource indicated by the network device changes, the network device may dynamically deactivate the P communication resources in the N communication resources by using the fourth information, so that the network device may not reconfigure a changed communication resource, reducing signaling overheads and implementation complexity, and improving communication efficiency. In addition, when the terminal device determines, based on the fourth information, that the P communication resources are unavailable communication resources, the terminal device may not perform measurement based on the P communication resources, reducing unnecessary overheads.

With reference to more accompanying drawings, the following describes the foregoing implementation process by using an example in which the communication resource is a cell indicated by a PCI.

It should be noted that in the following embodiment example, an example in which the first network device is SAT-1 is used. The N communication resources configured by using the N pieces of configuration information included in the first information sent by SAT-1 in step or operation S401 may include cells indicated by N PCIs and provided by SAT-1. As described above, the cells indicated by the N PCIs may further include a cell provided by another network device. In the following embodiment example, an example in which all the N communication resources are the cells indicated by the N PCIs and provided by SAT-1 is used for description.

Embodiment example 1: before handover between cell signal coverage due to movement of the network device, SAT-1 can carry and cover/serve cells indicated by the N PCIs, and reuse one or more cells in k cells corresponding to k (k is less than or equal to N) PCIs in the N cells for mobility management.

A main working procedure of SAT-1 is as follows:
in step or operation S401, SAT-1 sends the first information, where the first information includes the cell-related configuration information indicated by the set of N PCIs, for example, a cell identifier PCI, measurement frequency information, SMTC configuration information (broadcast beam measurement related information, including an SMTC periodicity, SMTC duration, and an SMTC offset), beam-level paging/access configuration (for example, cell barred) information, and a measurement priority. The SMTC configuration includes configuration information (such as multiple SMTC periodicities and SMTC duration information) of different broadcast beam sets in a handover process.

In step or operation S402, SAT-1 sends the second information. The first network device sends the second information by using one or more of the following information elements/interfaces (XnAP, MAC-CE, DCI, SIBx, RRC configuration/reconfiguration, and the like), to dynamically activate related configuration information of the set of M PCIs in the set of N PCIs (for example, MEN≤PCIs, where that some PCIs may be turned off is considered) by using the second information.

Optionally, in the embodiment example 1, the second information may include indexes of the M PCIs.

It may be understood that, in the cells indicated by the set of N PCIs, a cell indicated by each PCI may include M beams (for example, M SSBs, where values of M may be 4, 8, 64, and 128, and one or more of the M beams may serve a coverage area of the PCI through time division, space division, frequency division, or the like).

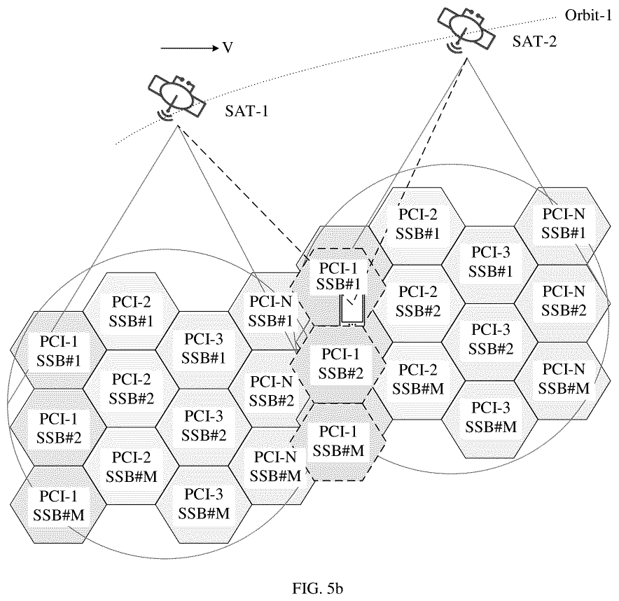

For example, as shown in FIG. 5a, in the embodiment example 1, before the handover between cell signal coverage due to movement of the network device, a single satellite carries N PCIs, for example, PCI-1, PCI-2, . . . , and PCI-N. Each PCI carries a maximum of M beams. For example, PCI-1 carries M beams (an SSB is used as an example), and an SSB broadcast periodicity is T1 (values of T1 may be 5 ms, 10 ms, 20 ms, 40 ms, 80 ms, and the like). The SSBs serve the coverage area of the PCI through one or more of time division, space division, or frequency division. For example, time division is used as an example. For the cell PCI-1 of the satellite SAT-1, SSB #1 is used to serve the area at a moment 1 (for example, a wave position 1), SSB #2 is used to serve the area at a moment 2 (for example, a wave position 2), and so on. SSB #M is used to serve a corresponding area at a moment M (for example, a wave position M). It may be noted that sets of PCIs carried by different satellites may be the same or may be different.

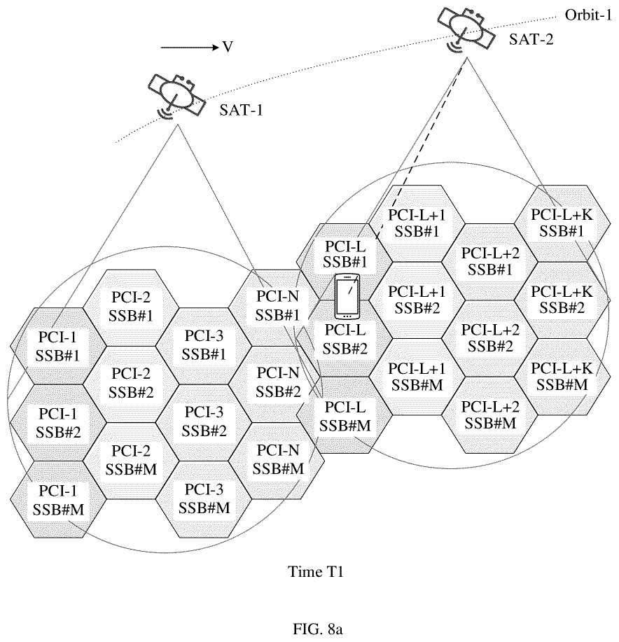

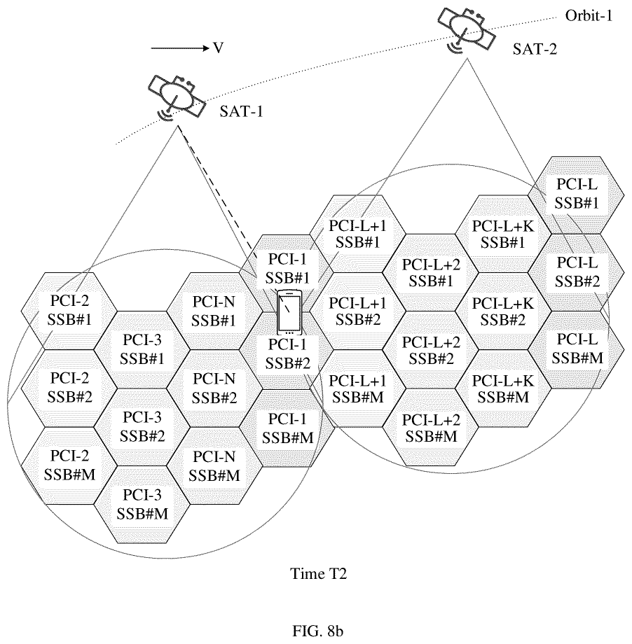

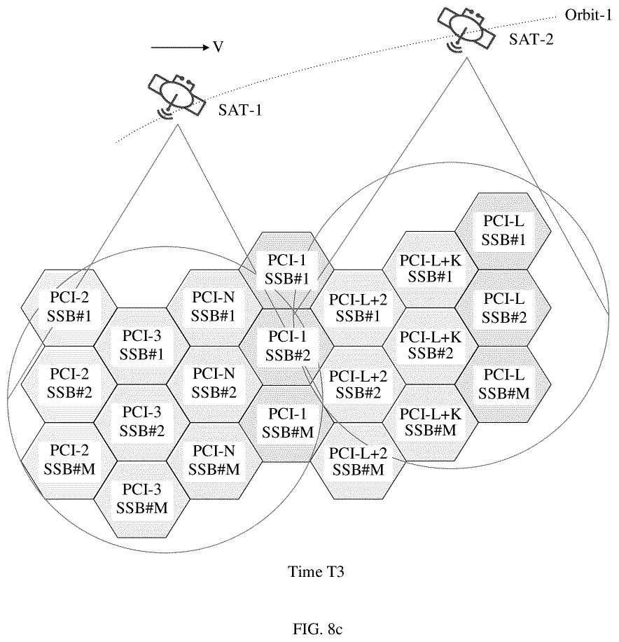

For example, as shown in FIG. 5b, in the embodiment example 1, during the handover between cell signal coverage due to movement of the network device, a single satellite carries N PCIs, for example, PCI-1, PCI-2, . . . , and PCI-N, but the coverage of PCI-1 is extended. As shown in FIG. 5a, SAT-1 is used as an example. In addition to covering an area on the left of the satellite SAT-1, PCI-1 also covers overlapping coverage of SAT-1 and SAT-2, to ensure that a user in the area seamlessly switches from SAT-2 to SAT-1 (for example, soft handover). In this case, PCI-1 may carry L*M SSBs (a value of L is determined based on area extension of PCI-1, and L=2 in FIG. 8b). It can be understood that the occurrence periodicity T2 of the handover-oriented SSB is different from T1 (the occurrence periodicity of T2 may be seconds or even hundreds of seconds, and values may be 1s, 5s, 10s, 20s, 40s, 80s, are the like), and the periodicity T1 may be reused in presence duration (or the periodicity may be different from T1). It can be seen that to ensure soft handover between cells, space domain/polarization domain multiplexing of a broadcast beam (SSB) may be supported. In addition, a beam-level cell barred (access barred) indication may be added to prevent UE in a area (for example, the area on the left of PCI-1) from accessing the cell when the cell is about to be turned off/leave.

For example, as shown in FIG. 5c, in the embodiment example 1, after the handover between cell signal coverage due to movement of the network device, a single satellite carries N PCIs, for example, PCI-1, PCI-2, . . . , and PCI-N. In addition, PCI-1 on the left of SAT-1 and the corresponding broadcast beam SSB are turned off, and PCI-1 carries M SSBs.

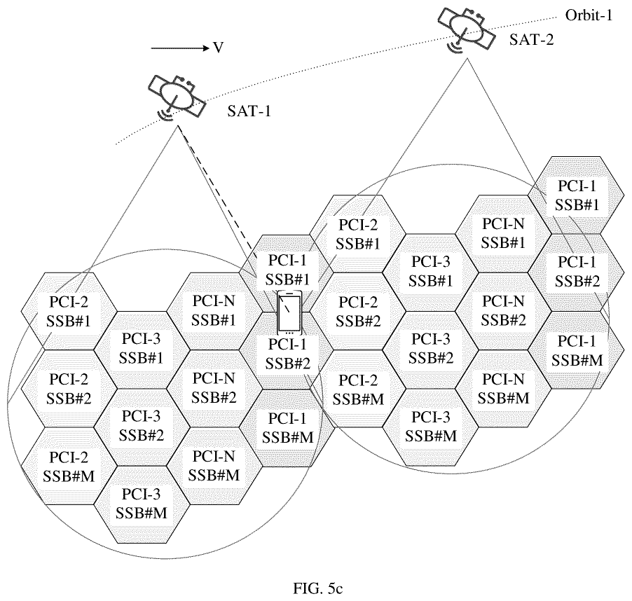

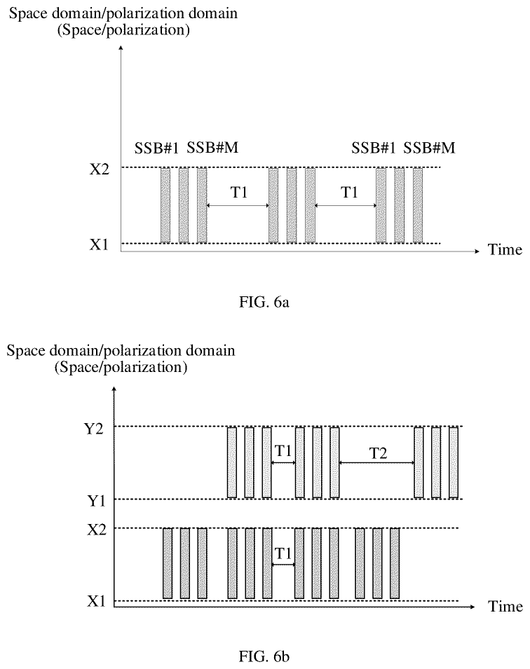

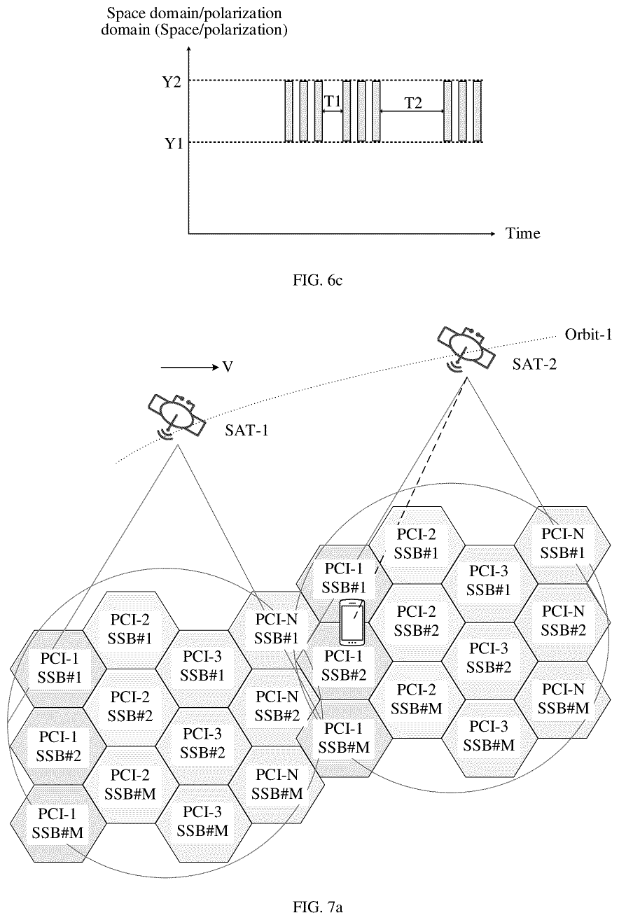

Optionally, before the handover and after the handover, space domain (space) information and polarization domain (polarization) information of the cell indicated by PCI-1 may vary. The following provides descriptions with reference to examples shown in FIG. 6a to FIG. 6c. In the following FIG. 6a to FIG. 6c, a horizontal coordinate represents time, and a vertical coordinate represents space domain information or polarization domain information.

As shown in FIG. 6a, before the handover, a value of space domain information or polarization domain information of the cell indicated by PCI-1 is associated with X1 and X2.

As shown in FIG. 6b, during the handover, PCI-1 indicates two cells. A value of space domain information or polarization domain information of one cell is associated with X1 and X2, and a value of space domain information or polarization domain information of the other cell is associated with Y1 and Y2. Value ranges of X1 and X2 do not completely overlap value ranges of Y1 and Y2. In the figure, an example in which the two value ranges do not overlap at all is used.

As shown in FIG. 6c, after the handover, a value of space domain information or polarization domain information of the cell indicated by PCI-1 is associated with Y1 and Y2.

It can be understood from the examples shown in FIG. 6a to FIG. 6c that a space domain and/or a polarization domain (for example, one or more of linear polarization, left-hand circular polarization, right-hand circular polarization, and elliptical polarization) different from that before the handover is used after the handover, so that space domains/polarization domains corresponding to a same PCI are different before and after the handover. When a same PCI is reused, the first network device or the terminal device can distinguish, based on the different space domain/polarization domains, communication resources used before and after the handover.

In the embodiment example 1, a main working procedure of the terminal device is as follows: the terminal device receives the first information in step or operation S401. Then, after receiving the second information in step or operation S402 and determining the cells corresponding to the set of M PCIs in the set of N PCIs, the terminal device performs corresponding operations such as neighboring cell measurement (and possible reporting) in step or operation S403, to assist mobility management (such as cell handover, cell reselection, and tracking area update) between the network device and the terminal device.

Embodiment example 2: before the handover between cell signal coverage due to movement of the network device, SAT-1 can carry and cover/serve cells indicated by N-k PCIs in the N cells, and reuse k cells corresponding to k (k is less than or equal to N) PCIs in the N cells for mobility management.

A main working procedure of SAT-1 is as follows:
in step or operation S401, SAT-1 sends the first information, where the first information includes the cell-related configuration information indicated by the set of N PCIs, for example, a cell identifier PCI, measurement frequency information, SMTC configuration information (broadcast beam measurement related information, including an SMTC periodicity, SMTC duration, and an SMTC offset), beam-level paging/access configuration (for example, cell barred) information, and a measurement priority. The SMTC configuration includes configuration information (such as multiple SMTC periodicities and SMTC duration information) of different broadcast beam sets in a handover process.

In step or operation S402, SAT-1 sends the second information. The first network device sends the second information by using one or more of the following information elements/interfaces (XnAP, MAC-CE, DCI, SIBx, RRC configuration/reconfiguration, and the like), to dynamically activate related configuration information of the set of M PCIs in the set of N PCIs (for example, MEN PCIs, where that some PCIs may be turned off is considered) by using the second information.

Optionally, in the embodiment example 2, the second information may include indexes of the M PCIs.

The following uses k=1 as an example to describe the PCI and broadcast beam changes during the entire handover process.

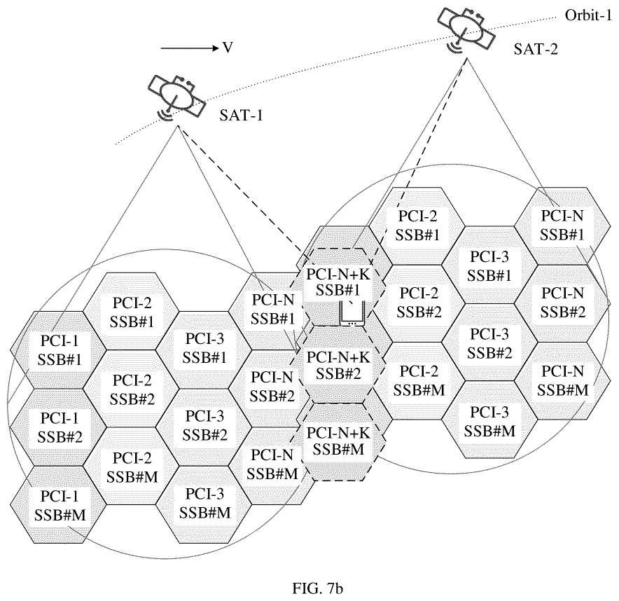

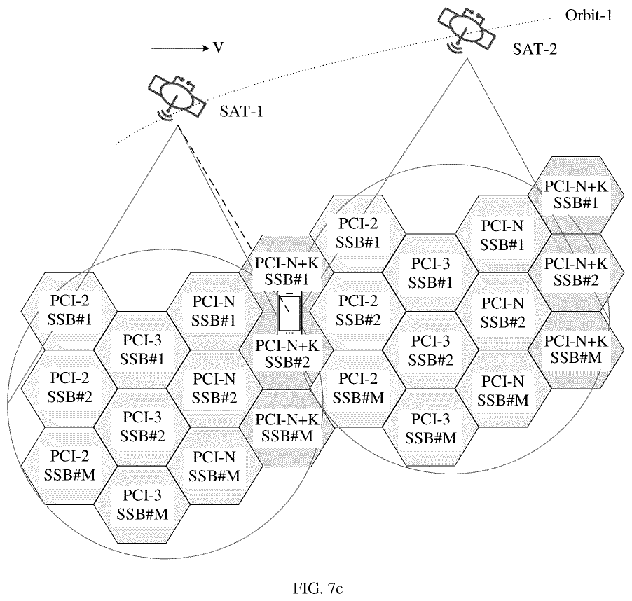

For example, as shown in FIG. 7a, in the embodiment example 2, before the handover between cell signal coverage due to movement of the network device, a single satellite carries N PCIs, for example, PCI-1, PCI-2, . . . , and PCI-N. For example, PCI-1 carries M beams (an SSB is used as an example), and an SSB periodicity is T1 (values of T1 may be 5 ms, 10 ms, 20 ms, 40 ms, 80 ms, and the like). It may be noted that sets of PCIs carried by different satellites may be the same or may be different.

For example, as shown in FIG. 7b, in the embodiment example 2, during the handover between cell signal coverage due to movement of the network device, a single satellite carries N+k (using k=1 as an example) PCIs, for example, PCI-1, PCI-2, . . . , PCI-N, and PCI-N+k. As shown in the figure, PCI-N+k serves overlapping coverage of SAT-1 and SAT-2, to ensure that a user in the area seamlessly switches from SAT-2 to SAT-1 (such as, soft handover). It may be noted that an identifier of PCI-N+k may be the same as or different from a PCI identifier in the set of N PCIs. In this case, each of PCI-1 and PCI-N+k may carry a maximum of M SSBs.

For example, as shown in FIG. 7c, in the embodiment example 2, after the handover between cell signal coverage due to movement of the network device, a single satellite carries N PCIs, for example, PCI-2, PCI-2, . . . , and PCI-N+1. PCI-1 on the left and a broadcast beam SSB corresponding to PCI-1 are turned off and switch to an inactive state. PCI-N+1 of the coverage area and a broadcast beam of PCI-N+1 cover the handover area and switch to an active state.

In the embodiment example 2, a main working procedure of the terminal device is as follows: the terminal device receives the first information in step or operation S401. Then, after receiving the second information in step or operation S402 and determining the cells corresponding to the set of M PCIs in the set of N PCIs, the terminal device performs corresponding operations such as neighboring cell measurement (and possible reporting) in step or operation S403, to assist mobility management (such as cell handover, cell reselection, and tracking area update) between the network device and the terminal device.

In an embodiment example, that a value of k is 1 and the first network device dynamically activates, by using the second information, the cells indicated by N (for example, values of N and M are equal) PCIs is used as an example. Measurement configurations performed by the terminal device may be shown in the following Table 1.

TABLE 1

| Time | | Cell configuration |
|---|---|---|
| periods | List of activated cells | information |
| T1-T2 | PCI-1, PCI-2, . . . , and PCI-N | Measurement configuration 1 |
| T3-T4 | PCI-1, PCI-2, . . . , PCI-N, PCI-N + 1, and PCI- | Measurement configuration 2 |
| | N + 1 | |
| T5-T6 | PCI-2, . . . , PCI-N, PCI-N + 1, and PCI-N + 2 | Measurement configuration 3 |
| . . . | . . . | . . . |

In Table 1, the time period “T1-T2” indicates before handover, the time period “T3-T4” indicates during handover, and the time period “T5-T5” indicates after handover.

Embodiment example 1: before the handover between cell signal coverage due to movement of the network device, SAT-1 can carry and cover/serve cells indicated by the N PCIs, and dynamically activate a part or all of the N cells by using an indication of shift information.

A main working procedure of SAT-1 is as follows:
in step or operation S401, SAT-1 sends the first information, where the first information includes the cell-related configuration information indicated by the set of N PCIs, for example, a cell identifier PCI, measurement frequency information, SMTC configuration information (broadcast beam measurement related information, including an SMTC periodicity, SMTC duration, and an SMTC offset), beam-level paging/access configuration (for example, cell barred) information, and a measurement priority. The SMTC configuration includes configuration information (such as multiple SMTC periodicities and SMTC duration information) of different broadcast beam sets in a handover process.

It may be understood that, in the embodiment example 3, the cell-related configuration information includes reference information of one or more cells in a cell cluster/list, and the reference information generally remains unchanged for a long time, for example, an orbit period (about dozens of minutes) or even a longer time scale. The reference information may include one or more of the following: a cell identifier, cell frequency/polarization (such as linear polarization, circular polarization, and elliptic polarization) information, and measurement configuration related information (such as an SMTC periodicity, SMTC duration, an SMTC offset, a measurement gap configuration, a neighboring cell measurement priority, and a frequency/polarization priority).

In step or operation S402, SAT-1 sends the second information, where the second information includes shift information, and the shift information indicates cyclic shifts of different communication resources in a handover process, so that a receiver of the second information can determine, based on the shift information, a cell indicated by a PCI activated by SAT-1 at a moment.

Optionally, the shift information may indicate shift information relative to a cell cluster/list, and may be, for example, represented as one or more of a shift factor (for example, 1 indicates shifting rightwards by 1 as a whole, and so on), an activation state (for example, 0 indicates active, 1 indicates inactive, and a bitmap indicates an activation status of the cell list), and a valid time period.

For example, the following describes the embodiment example 3 with reference to more accompanying drawings.

When SAT-1 carries a same set of PCIs, PCI patterns at different moments are as follows:

(1) As shown in FIG. 8a, at Time T1, the set of N PCIs carried by SAT1 and SAT-2 is: PCI-1, PCI-2, . . . , and PCI-N.

(2) As shown in FIG. 8b, at Time T2, SAT-1 moves out of a coverage area originally corresponding to PCI-1, and takes over a coverage area originally corresponding to PCI-1 of SAT-2. The set of N PCIs carried by SAT1 and SAT-2 is: PCI-2, . . . , PCI-N, and PCI-1.

(3) As shown in FIG. 8c, at Time T3, the coverage area shrinks, PCI-2 of SAT-2 is turned off, the set of PCIs carried by SAT1 is: PCI-2, . . . , PCI-N, and PCI-1, and the set of PCIs carried by SAT2 is: PCI-3, . . . , PCI-N, and PCI-1.

When the satellites carry different sets of PCIs, PCI patterns at different moments are as follows:

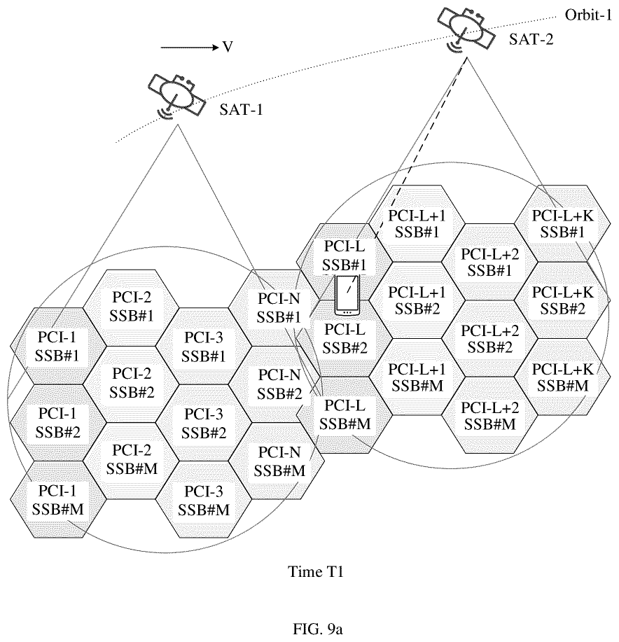

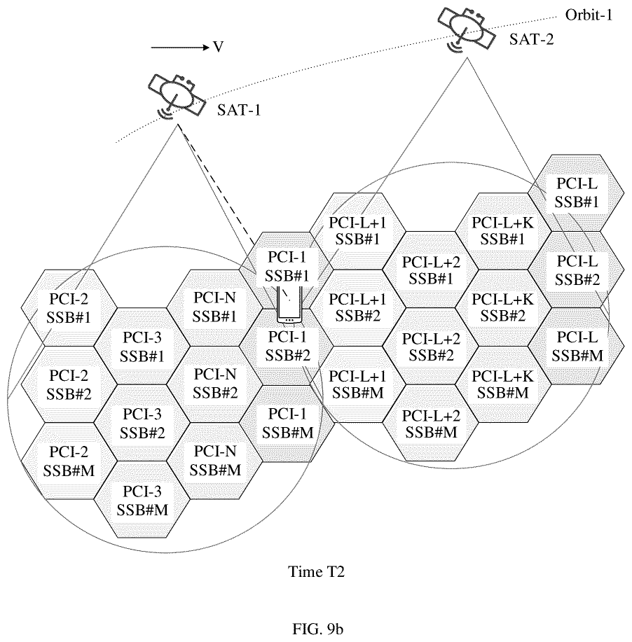

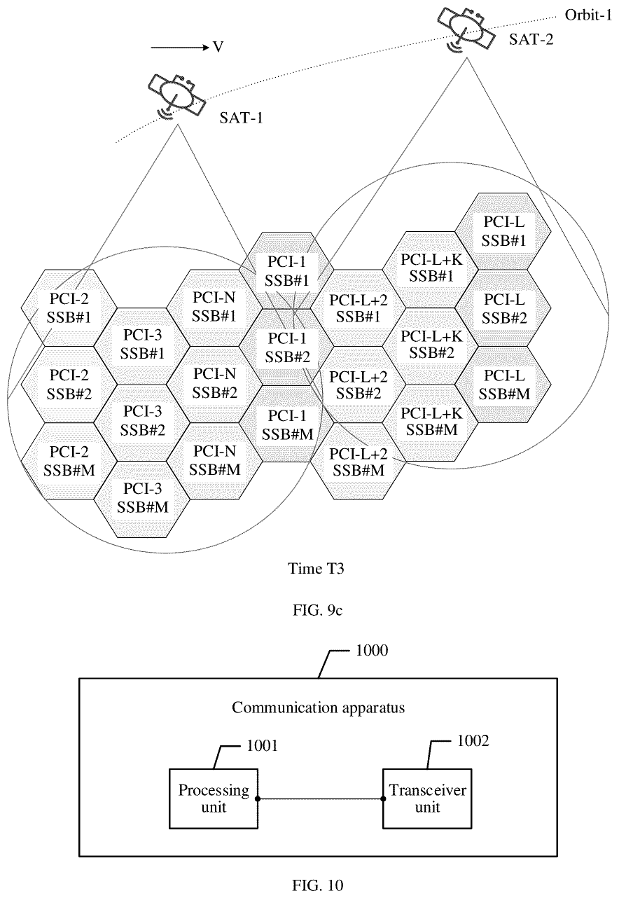

(1) As shown in FIG. 9a, at Time T1, SAT1 carries a set of N PCIs: PCI-1, PCI-2, . . . , and PCI-N. SAT-2 carries a set of k PCIs: PCI-L, PCI-L+1, . . . , and PCI-L+k.

(2) As shown in FIG. 9b, at Time T2, SAT-1 moves out of a coverage area originally corresponding to PCI-1, and takes over a coverage area originally corresponding to PCI-L of SAT-2. The set of PCIs carried by SAT1 is: PCI-2, . . . , PCI-N, and PCI-1, and the set of PCIs carried by SAT2 is: PCI-L+1, . . . , PCI-L+k, and PCI-L.

(3) As shown in FIG. 9c, at Time T3, the coverage area shrinks, PCI-2 of SAT-2 is turned off, the set of PCIs carried by SAT1 is: PCI-2, . . . , PCI-N, and PCI-1, and the set of PCIs carried by SAT2 is: PCI-L+2, . . . , PCI-L+k, and PCI-L.

In the embodiment example 1, a main working procedure of the terminal device is as follows: the terminal device receives the first information in step or operation S401. Then, after receiving the shift information carried in the second information in step or operation S402 and determining the cells corresponding to the set of M PCIs in the set of N PCIs, the terminal device performs corresponding operations such as neighboring cell measurement (and possible reporting) in step or operation S403, to assist mobility management (such as cell handover, cell reselection, and tracking area update) between the network device and the terminal device.

S404: the second network device determines the M communication resources based on the first information and the second information. The second network device may determine the M communication resources in step or operation S404 based on the first information received in step or operation S401 and the second information received in step or operation S402.

It may be noted that after the second network device determines the M communication resources based on the first information and the second information in step or operation S404, the second network device may update neighboring cell relationship information (for example, a neighbor relation table (NRT) and/or a neighboring cell list (NCL)) based on one or more communication resources in the M communication resources, and the second network device may further determine, based on the neighboring cell relationship information (and other information that may exist, for example, ephemeris information of the second network device and ephemeris information of the first network device), one or more communication resources to be dynamically activated by the second network device subsequently, or the second network device may further perform another operation. This is not limited herein.

In a possible embodiment, in the method shown in FIG. 4, the method further includes: the first network device sends fourth information, and correspondingly, the second network device receives the fourth information, where the fourth information indicates that P communication resources in the N communication resources are unavailable communication resources, and P is a positive integer. For example, when the first network device moves and the communication resource indicated by the first network device changes, the first network device may dynamically deactivate the P communication resources in the N communication resources by using the fourth information, so that the first network device may not reconfigure a changed communication resource, reducing signaling overheads and implementation complexity, and improving communication efficiency.

Based on FIG. 4 and the related solutions, the N pieces of configuration information included in the first information sent by the first network device in step or operation S401 are respectively used to configure the N communication resources, and the second information sent by the first network device in step or operation S402 indicates the M communication resources in the N communication resources, so that a receiver of the first information and the second information can determine the M communication resources based on the first information and the second information. Therefore, when the first network device moves and the communication resource indicated by the first network device changes, the first network device can dynamically activate (enable, turn on, or the like) the M communication resources in the N communication resources by using the second information, so that the first network device may not reconfigure a changed communication resource, reducing signaling overheads and implementation complexity, and improving communication efficiency.

Refer to FIG. 10. An embodiment provides a communication apparatus 1000. The communication apparatus 1000 can implement a function of the terminal device (or the network device) in the foregoing method embodiments, and therefore can also achieve beneficial effects of the foregoing method embodiments. In this embodiment, the communication apparatus 1000 may be a terminal device (or a network device), or may be an integrated circuit, an element, or the like inside the terminal device (or the network device), for example, a chip. In the following embodiments, an example in which the communication apparatus 1000 is a terminal device or a network device is used for description.

In a possible embodiment, when the apparatus 1000 is configured to perform the method performed by the terminal device in any one of the foregoing embodiments, the apparatus 1000 includes a processing unit 1001 and a transceiver unit 1002. The transceiver unit 1002 is configured to receive first information, where the first information includes N pieces of configuration information, the N pieces of configuration information are respectively used to configure N communication resources, and N is an integer greater than 1; the transceiver unit 1002 is further configured to receive second information, where the second information indicates M communication resources in the N communication resources, and M is a positive integer less than or equal to N; and the processing unit 1001 is configured to measure at least one of the M communication resources based on the first information and the second information.

In a possible embodiment, the N pieces of configuration information include k pieces of first configuration information and N-k pieces of second configuration information, and k communication resources configured by using the k pieces of first configuration information are used for mobility management upon a communication resource change, where k is a positive integer.

In a possible embodiment, the N communication resources include k first communication resources and N-k second communication resources. Before the communication resource changes, a quantity of communication resources carried by a satellite in a non-terrestrial network communication system is equal to a quantity of second communication resources, and k is a positive integer.

In a possible embodiment, the N communication resources include a communication resource at a current moment and/or a communication resource at one or more future moments.

In a possible embodiment, the communication resource includes any one of the following: a cell indicated by a physical cell identifier PCI, a broadcast beam, a traffic beam, and a synchronization signal block SSB.

In a possible embodiment, the transceiver unit 1002 is further configured to send third information, where the third information indicates a result of the measurement.

In a possible embodiment, the second information includes indexes of the M communication resources.

In a possible embodiment, the second information includes effective time information corresponding to the N communication resources, and the effective time information and the current moment are used to determine the M pieces of configuration information; and/or the second information includes shift information corresponding to the N communication resources, and the shift information and the current moment are used to determine the M pieces of configuration information.

In a possible embodiment, each of the N communication resources corresponds to a first identifier and a second identifier. The first identifier is used to identify a resource index of each communication resource, and the second identifier is used to identify space domain information and/or polarization domain information of each communication resource. The M communication resources meet any one of the following: s first identifier corresponding to one of the M communication resources is the same as a first identifier corresponding to a target communication resource, and a second identifier corresponding to one of the M communication resources is different from a second identifier corresponding to the target communication resource, where the target communication resource is a communication resource other than the M communication resources in the N communication resources. Alternatively, a first identifier corresponding to any one of the M communication resources is different from the first identifier corresponding to the target communication resource.

In a possible embodiment, when the apparatus 1000 is configured to perform the method performed by the first network device in any one of the foregoing embodiments, the apparatus 1000 includes a processing unit 1001 and a transceiver unit 1002. The processing unit 1001 is configured to determine first information and second information; the transceiver unit 1002 is configured to send the first information, where the first information includes N pieces of configuration information, the N pieces of configuration information are respectively used to configure N communication resources, and N is an integer greater than 1; and the transceiver unit 1002 is further configured to send the second information, where the second information indicates M communication resources in the N communication resources, and M is a positive integer less than or equal to N.

In a possible embodiment, the N pieces of configuration information include k pieces of first configuration information and N-k pieces of second configuration information, and k communication resources configured by using the k pieces of first configuration information are used for mobility management upon a communication resource change, where k is a positive integer.

In a possible embodiment, the N communication resources include a communication resource at a current moment and/or a communication resource at one or more future moments.

In a possible embodiment, the communication resource includes any one of the following: a cell indicated by a physical cell identifier PCI, a broadcast beam, a traffic beam, and a synchronization signal block SSB.

In a possible embodiment, the transceiver unit 1002 is further configured to receive third information, where the third information indicates a result of the measurement.

In a possible embodiment, the second information includes indexes of the M communication resources.

In a possible embodiment, the second information includes effective time information corresponding to the N communication resources, and the effective time information and the current moment are used to determine the M pieces of configuration information; and/or the second information includes shift information corresponding to the N communication resources, and the shift information and the current moment are used to determine the M pieces of configuration information.

In a possible embodiment, each of the N communication resources corresponds to a first identifier and a second identifier. The first identifier is used to identify a resource index of each communication resource, and the second identifier is used to identify space domain information and/or polarization domain information of each communication resource. The M communication resources meet any one of the following: a first identifier corresponding to one of the M communication resources is the same as a first identifier corresponding to a target communication resource, and a second identifier corresponding to one of the M communication resources is different from a second identifier corresponding to the target communication resource, where the target communication resource is a communication resource other than the M communication resources in the N communication resources. Alternatively, a first identifier corresponding to any one of the M communication resources is different from the first identifier corresponding to the target communication resource.

In a possible embodiment, when the apparatus 1000 is configured to perform the method performed by the second network device in any one of the foregoing embodiments, the apparatus 1000 includes a processing unit 1001 and a transceiver unit 1002. The transceiver unit 1002 is configured to receive first information, where the first information includes N pieces of configuration information, the N pieces of configuration information are respectively used to configure N communication resources, and N is an integer greater than 1; the transceiver unit 1002 is further configured to receive second information, where the second information indicates M communication resources in the N communication resources, and M is a positive integer less than or equal to N; and the processing unit 1001 is configured to determine the M communication resources based on the first information and the second information.

In a possible embodiment, the N pieces of configuration information include k pieces of first configuration information and N-k pieces of second configuration information, and k communication resources configured by using the k pieces of configuration information are used for mobility management upon a communication resource change, where k is a positive integer.

In a possible embodiment, the N communication resources include a communication resource at a current moment and/or a communication resource at one or more future moments.

In a possible embodiment, the communication resource includes any one of the following: a cell indicated by a physical cell identifier PCI, a broadcast beam, a traffic beam, and a synchronization signal block SSB.

In a possible embodiment, the second information includes indexes of the M communication resources.

In a possible embodiment, the second information includes effective time information corresponding to the N communication resources, and the effective time information and the current moment are used to determine the M pieces of configuration information; and/or the second information includes shift information corresponding to the N communication resources, and the shift information and the current moment are used to determine the M pieces of configuration information.

In a possible embodiment, each of the N communication resources corresponds to a first identifier and a second identifier. The first identifier is used to identify a resource index of each communication resource, and the second identifier is used to identify space domain information and/or polarization domain information of each communication resource. The M communication resources meet any one of the following: a first identifier corresponding to one of the M communication resources is the same as a first identifier corresponding to a target communication resource, and a second identifier corresponding to one of the M communication resources is different from a second identifier corresponding to the target communication resource, where the target communication resource is a communication resource other than the M communication resources in the N communication resources. Alternatively, a first identifier corresponding to any one of the M communication resources is different from the first identifier corresponding to the target communication resource.

In a possible embodiment, the transceiver unit 1002 is further configured to receive fourth information, where the fourth information indicates that P communication resources in the N communication resources are unavailable communication resources, and P is a positive integer.

It may be noted that for details of content such as an information execution process of the unit of the communication apparatus 1000, refer to descriptions in the foregoing method embodiments. Details are not described herein again.

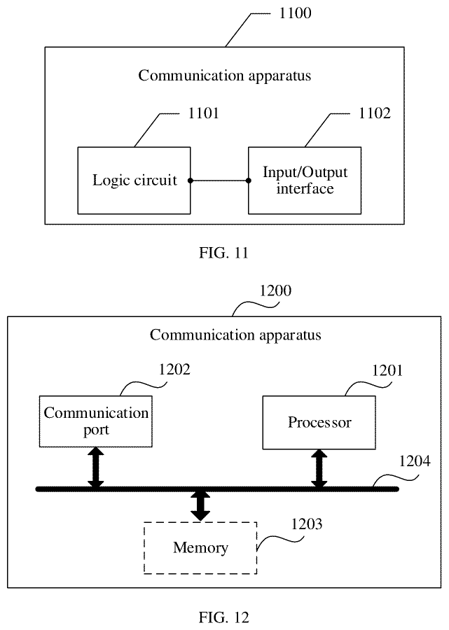

FIG. 11 is another diagram of a structure of a communication apparatus 1100 according to the embodiments. The communication apparatus 1100 includes at least an input/output interface 1102. The communication apparatus 1100 may be a chip or an integrated circuit.

Optionally, the communication apparatus further includes a logic circuit 1101.

The transceiver unit 1002 shown in FIG. 10 may be a communication interface. The communication interface may be the input/output interface 1102 in FIG. 11, and the input/output interface 1102 may include an input interface and an output interface. Alternatively, the communication interface may be a transceiver circuit, and the transceiver circuit may include an input interface circuit and an output interface circuit.

Optionally, the input/output interface 1102 is configured to receive first information, where the first information includes N pieces of configuration information, the N pieces of configuration information are respectively used to configure N communication resources, and N is an integer greater than 1; the input/output interface 1102 is further configured to receive second information, where the second information indicates M communication resources in the N communication resources, and M is a positive integer less than or equal to N; and the logic circuit 1101 is configured to measure at least one of the M communication resources based on the first information and the second information. The logic circuit 1101 and the input/output interface 1102 may further perform other steps or operations performed by the terminal device in any one of the foregoing embodiments, and achieve corresponding beneficial effects. Details are not described herein again.

Optionally, the logic circuit 1101 is configured to determine first information and second information; the input/output interface 1102 is configured to send the first information, where the first information includes N pieces of configuration information, the N pieces of configuration information are respectively used to configure N communication resources, and N is an integer greater than 1; and the input/output interface 1102 is further configured to send the second information, where the second information indicates M communication resources in the N communication resources, and Mis a positive integer less than or equal to N. The logic circuit 1101 and the input/output interface 1102 may further perform other steps or operations performed by the first network device in any one of the foregoing embodiments, and achieve corresponding beneficial effects. Details are not described herein again.

Optionally, the input/output interface 1102 is configured to receive first information, where the first information includes N pieces of configuration information, the N pieces of configuration information are respectively used to configure N communication resources, and N is an integer greater than 1; the input/output interface 1102 is further configured to receive second information, where the second information indicates M communication resources in the N communication resources, and M is a positive integer less than or equal to N; and the logic circuit 1101 is configured to determine the M communication resources based on the first information and the second information. The logic circuit 1101 and the input/output interface 1102 may further perform other steps or operations performed by the second network device in any one of the foregoing embodiments, and achieve corresponding beneficial effects. Details are not described herein again.

In a possible embodiment, the processing unit 1001 shown in FIG. 10 may be the logic circuit 1101 in FIG. 11.

Optionally, the logic circuit 1101 may be a processing apparatus, and some or all of functions of the processing apparatus may be implemented by software. Some or all functions of the processing apparatus may be implemented through software.

Optionally, the processing apparatus may include a memory and a processor. The memory is configured to store a computer program, and the processor reads and executes the computer program stored in the memory, to perform corresponding processing and/or steps or operations in any method embodiment.

Optionally, the processing apparatus may include only a processor. A memory configured to store a computer program is located outside the processing apparatus, and the processor is connected to the memory through a circuit/wire, to read and execute the computer program stored in the memory. The memory and the processor may be integrated together, or may be physically independent of each other.

Optionally, the processing apparatus may be one or more chips or one or more integrated circuits. For example, the processing apparatus may be one or more field-programmable gate arrays (FPGA), application-specific integrated circuits (ASIC), systems on chips (SoC), central processing units (CPU), network processors (NP), digital signal processors (DSP), microcontroller units (MCU), programmable logic devices (PLD), or other integrated chips, or any combination of the foregoing chips or processors.

FIG. 12 is a communication apparatus 1200 in the foregoing embodiments according to an embodiment. The communication apparatus 1200 may be, for example, a communication apparatus serving as a terminal device in the foregoing embodiments. An example shown in FIG. 12 is that the terminal device is implemented as a terminal device (or a component in the terminal device).

In a possible diagram of a logical structure of the communication apparatus 1200, the communication apparatus 1200 may include but is not limited to at least one processor 1201 and a communication port 1202.

Further, optionally, the apparatus may include at least either of a memory 1203 and a bus 1204. In this embodiment, the at least one processor 1201 is configured to perform control processing on an action of the communication apparatus 1200.

In addition, the processor 1201 may be a central processing unit, a general-purpose processor, a digital signal processor, an application-specific integrated circuit, a field programmable gate array or another programmable logic device, a transistor logic device, a hardware component, or any combination thereof. The processor may implement or execute various example logical blocks, modules, and circuits described with reference to content in the embodiments. Alternatively, the processor may be a combination of processors implementing a computing function, for example, a combination of one or more microprocessors, or a combination of a digital signal processor and a microprocessor. It may be understood by a person skilled in the art that, for the purpose of convenient and brief description, for a detailed working process of the foregoing system, apparatus, and unit, refer to a corresponding process in the foregoing method embodiments, and details are not described herein again.

It may be noted that, the communication apparatus 1200 shown in FIG. 12 may be, for example, configured to implement steps or operations implemented by the terminal device in the foregoing method embodiments, and achieve effects corresponding to the terminal device. For an embodiment of the communication apparatus shown in FIG. 12, refer to the descriptions in the foregoing method embodiments. Details are not described herein again.

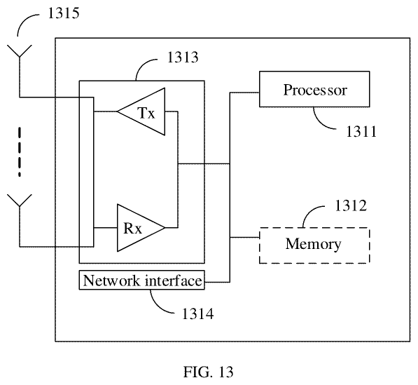

FIG. 13 is a diagram of a structure of a communication apparatus 1300 in the foregoing embodiments according to an embodiment. The communication apparatus 1300 may be, for example, a communication apparatus serving as a network device in the foregoing embodiments. In an example shown in FIG. 13, the network device is implemented as a network device (or a component in the network device). For a structure of the communication apparatus, refer to the structure shown in FIG. 13.

The communication apparatus 1300 includes at least one processor 1311 and at least one network interface 1314. Further, optionally, the communication apparatus further includes at least one memory 1312, at least one transceiver 1313, and one or more antennas 1315. The processor 1311, the memory 1312, the transceiver 1313, and the network interface 1314 are connected, for example, through a bus. In this embodiment, the connection may include various interfaces, transmission lines, buses, or the like. This is not limited. The antenna 1315 is connected to the transceiver 1313. The network interface 1314 is configured to enable the communication apparatus to communicate with another communication device through a communication link. For example, the network interface 1314 may include a network interface between the communication apparatus and a core network device, for example, an SI interface. The network interface may include a network interface between the communication apparatus and another communication apparatus (for example, another network device or core network device), for example, an X2 interface or an Xn interface.

The processor 1311 is configured to process a communication protocol and communication data, control the entire communication apparatus, execute a software program, and process data of the software program, for example, is configured to support the communication apparatus in performing actions described in embodiments. The communication apparatus may include a baseband processor and a central processing unit. The baseband processor is configured to process the communication protocol and the communication data. The central processing unit is configured to: control an entire terminal device, execute the software program, and process the data of the software program. The processor 1311 in FIG. 13 may integrate functions of the baseband processor and the central processing unit. A person skilled in the art may understand that the baseband processor and the central processing unit may alternatively be independent processors, and are interconnected by using a technology such as a bus. A person skilled in the art may understand that the terminal device may include multiple baseband processors to adapt to different network standards, and the terminal device may include multiple central processing units to enhance processing capabilities of the terminal device, and components of the terminal device may be connected by using various buses. The baseband processor may also be expressed as a baseband processing circuit or a baseband processing chip. The central processing unit may also be expressed as a central processing circuit or a central processing chip. A function of processing the communication protocol and the communication data may be built in the processor, or may be stored in the memory in a form of software program, and the processor executes the software program to implement a baseband processing function.

The memory is configured to store the software program and data. The memory 1312 may exist independently, and is connected to the processor 1311. Optionally, the memory 1312 and the processor 1311 may be integrated together, for example, integrated into one chip. The memory 1312 can store program code for executing the solutions in embodiments, and execution is controlled by the processor 1311. Various types of executed computer program code may also be considered as drivers of the processor 1311.

FIG. 13 shows only one memory and one processor. A terminal may include multiple processors and multiple memories. The memory may also be referred to as a storage medium, a storage device, or the like. The memory may be a storage element on a same chip as the processor, for example, an on-chip storage element, or may be an independent storage element. This is not limited.

The transceiver 1313 may be configured to support receiving or sending of a radio frequency signal between the communication apparatus and the terminal, and the transceiver 1313 may be connected to the antenna 1315. The transceiver 1313 includes a transmitter machine Tx and a receiver machine Rx. For example, the one or more antennas 1315 may receive a radio frequency signal. The receiver machine Rx in the transceiver 1313 is configured to receive the radio frequency signal from the antenna, convert the radio frequency signal into a digital baseband signal or a digital intermediate frequency signal, and provide the digital baseband signal or the digital intermediate frequency signal for the processor 1311, so that the processor 1311 performs further processing on the digital baseband signal or the digital intermediate frequency signal, for example, performs demodulation processing and decoding processing. In addition, the transmitter machine Tx in the transceiver 1313 is further configured to receive a modulated digital baseband signal or digital intermediate frequency signal from the processor 1311, convert the modulated digital baseband signal or digital intermediate frequency signal into a radio frequency signal, and send the radio frequency signal through the one or more antennas 1315. For example, the receiver machine Rx may selectively perform one-level or multi-level down mixing processing and analog-to-digital conversion processing on the radio frequency signal, to obtain the digital baseband signal or the digital intermediate frequency signal. A sequence of the down mixing processing and the analog-to-digital conversion processing may be adjusted. The transmitter machine Tx may selectively perform one-level or multi-level up mixing processing and digital-to-analog conversion processing on the modulated digital baseband signal or digital intermediate frequency signal, to obtain the radio frequency signal. A sequence of the up mixing processing and the digital-to-analog conversion processing may be adjusted. The digital baseband signal and the digital intermediate frequency signal may be collectively referred to as a digital signal.

The transceiver 1313 may also be referred to as a transceiver unit, a transceiver machine, a transceiver apparatus, or the like. Optionally, a device that is in the transceiver unit and that is configured to implement a receiving function may be considered as a receiving unit, and a device that is in the transceiver unit and that is configured to implement a sending function may be considered as a sending unit. In other words, the transceiver unit includes the receiving unit and the sending unit. The receiving unit may also be referred to as a receiver machine, an input port, a receiving circuit, or the like. The sending unit may be referred to as a transmitter machine, a transmitter, a transmitter circuit, or the like.

It may be noted that, the communication apparatus 1300 shown in FIG. 13 may be, for example, configured to implement steps or operations implemented by the network device in the foregoing method embodiments, and achieve effects corresponding to the network device. For an embodiment of the communication apparatus 1300 shown in FIG. 13, refer to the descriptions in the foregoing method embodiments. Details are not described herein again.

An embodiment further provides a non-transitory computer-readable storage medium storing one or more computer-executable instructions. When the computer-executable instructions are executed by a processor, the processor performs the method in the possible embodiments of the terminal device in the foregoing embodiments.

An embodiment of further provides a non-transitory computer-readable storage medium storing one or more computer-executable instructions. When the computer-executable instructions are executed by a processor, the processor performs the method in the possible embodiments of the network device (for example, the first network device or the second network device) in the foregoing embodiments.

An embodiment of further provides a computer program product (or referred to as a computer program) storing one or more computer-executable instructions. When the computer program product is executed by a processor, the processor performs the method in the possible embodiments of the terminal device.

An embodiment of further provides a computer program product storing one or more computer-executable instructions. When the computer program product is executed by a processor, the processor performs the method in the possible embodiments of the network device (for example, the first network device or the second network device).

An embodiment of further provides a chip system. The chip system includes at least one processor, configured to support a communication apparatus in implementing a function in the possible embodiments of the communication apparatus. Optionally, the chip system further includes an interface circuit, and the interface circuit provides program instructions and/or data for the at least one processor. In a possible embodiment, the chip system may further include a memory. The memory is configured to store program instructions and data that may be used by the communication apparatus. The chip system may include a chip, or may include a chip and another discrete component. The communication apparatus may be, for example, the terminal device in the foregoing method embodiments.

An embodiment of further provides a chip system. The chip system includes at least one processor, configured to support a communication apparatus in implementing a function in the possible embodiments of the communication apparatus. Optionally, the chip system further includes an interface circuit, and the interface circuit provides program instructions and/or data for the at least one processor. In a possible embodiment, the chip system may further include a memory. The memory is configured to store program instructions and data that may be used by the communication apparatus. The chip system may include a chip, or may include a chip and another discrete component. The communication apparatus may be, for example, the network device in the foregoing method embodiments (for example, the first network device or the second network device).

An embodiment of further provides a communication system. The network system architecture includes at least two devices of the terminal device, the first network device, and the second network device in any one of the foregoing embodiments.

In the several embodiments, it may be understood that the system, apparatus, and method may be implemented in other manners. For example, the described apparatus embodiments are merely examples. For example, division into the units is logical function division and may be other division in some embodiments. For example, multiple units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electric, mechanical, or other forms.

The units described as separate parts may or may not be physically separate, and parts displayed as units may or may not be physical units, may be located in one position, or may be distributed on multiple network units. Some or all of the units may be selected based on requirements to achieve the objectives of the solutions of embodiments.

In addition, functional units in embodiments may be integrated into one processing unit, or each of the units may exist alone physically, or two or more units may be integrated into one unit. The integrated unit may be implemented in a form of hardware, or may be implemented in a form of software functional unit. When the integrated unit is implemented in the form of software functional unit and sold or used as an independent product, the integrated unit may be stored in a non-transitory computer-readable storage medium. Based on such an understanding, the solutions of the embodiments, or the part making contribution, or all or some of the solutions may be implemented in a form of software product. The computer software product is stored in a storage medium and includes several instructions for instructing a computer device (which may be a personal computer, a server, a network device, or the like) to perform all or some of the steps or operations of the methods described in embodiments. The storage medium includes any medium that can store program code, such as a USB flash drive, a removable hard disk, a read-only memory (ROM), a random access memory (RAM), a magnetic disk, or an optical disc.

It should be understood that all embodiments are merely exemplary and non-limiting, and that any modification or variation made by a person of ordinary skill in the art shall fall within the scope of the embodiments described herein.

1. A method, applied to a non-terrestrial network communication system, the method comprising:
receiving first information, wherein the first information comprises N pieces of configuration information, the N pieces of configuration information are respectively used to configure N communication resources, and N is an integer greater than 1;
receiving second information, wherein the second information indicates M communication resources in the N communication resources, and M is a positive integer less than or equal to N; and
measuring at least one of the M communication resources to assist in mobility management of the non-terrestrial network communication system.

2. The method according to claim 1, wherein the at least one of the M communication resources comprises at least one of the following: a cell indicated by a physical cell identifier PCI, a broadcast beam, a traffic beam, or a synchronization signal block SSB.

3. The method according to claim 1, wherein the at least one of the M communication resources comprises at least one of a communication resource at a current moment and a communication resource at one or more future moments.

4. The method according to claim 1, wherein the mobility management comprises at least one of cell handover, cell reselection, registration area update, and tracking area update.

5. The method according to claim 1, wherein the N pieces of configuration information comprise k pieces of first configuration information and N-k pieces of second configuration information, and k communication resources configured by using the k pieces of first configuration information are used for the mobility management upon a change of the N communication resources, wherein k is a positive integer.

6. The method according to claim 1, further comprising:
sending third information, wherein the third information indicates a result of the measurement.

7. The method according to claim 1, wherein the second information comprises indexes of the M communication resources.

8. The method according to claim 1, wherein the second information comprises at least one of the following:
effective time information corresponding to the N communication resources, and the effective time information and a current moment are used to determine the M pieces of configuration information; or
the second information comprises shift information corresponding to the N communication resources, and the shift information and the current moment are used to determine M pieces of configuration information.

9. The method according to claim 1, wherein each of the N communication resources corresponds to a first identifier and a second identifier, the first identifier is used to identify a resource index of each communication resource, and the second identifier is used to identify at least one of space domain information or polarization domain information of each communication resource; and
the M communication resources meet any one of the following:
a first identifier corresponding to one of the M communication resources is the same as a first identifier corresponding to a target communication resource, and a second identifier corresponding to one of the M communication resources is different from a second identifier corresponding to the target communication resource, wherein the target communication resource is a communication resource other than the M communication resources in the N communication resources; or
a first identifier corresponding to any one of the M communication resources is different from the first identifier corresponding to the target communication resource.

10. The method according to claim 1, further comprising:
receiving fourth information, wherein the fourth information indicates that P communication resources in the N communication resources are unavailable for measurement, and P is a positive integer.

11. A communication apparatus, applicable to a non-terrestrial network communication system, comprising:
a transceiver configured to receive first information, wherein the first information comprises N pieces of configuration information, the N pieces of configuration information are respectively used to configure N communication resources, and Nis an integer greater than 1;
the transceiver further configured to receive second information, wherein the second information indicates M communication resources in the N communication resources, and M is a positive integer less than or equal to N; and
a processor configured to measure at least one of the M communication resources to assist in mobility management of the non-terrestrial network communication system.

12. The apparatus according to claim 11, wherein the at least one of the M communication resources comprises at least one of the following:
a cell indicated by a physical cell identifier PCI, a broadcast beam, a traffic beam, and a synchronization signal block SSB.

13. The apparatus according to claim 11, wherein the at least one of the M communication resources comprises at least one of a communication resource at a current moment or a communication resource at one or more future moments.

14. The apparatus according to claim 11, wherein the mobility management comprises at least one of cell handover, cell selection, cell reselection, registration area update, and tracking area update.

15. The apparatus according to claim 11, wherein the N pieces of configuration information comprise k pieces of first configuration information and N-k pieces of second configuration information, and k communication resources configured by using the k pieces of first configuration information are used for the mobility management upon a change of the N communication resources, wherein k is a positive integer.

16. The apparatus according to claim 11, wherein the transceiver is further configured to send third information, wherein the third information indicates a result of the measurement.

17. The apparatus according to claim 11, wherein the second information comprises indexes of the M communication resources.

18. The apparatus according to claim 11, wherein the second information comprises at least one of the following:
effective time information corresponding to the N communication resources, and the effective time information and a current moment are used to determine the M pieces of configuration information; or
the second information comprises shift information corresponding to the N communication resources, and the shift information and the current moment are used to determine the M pieces of configuration information.

19. The apparatus according to claim 11, wherein each of the N communication resources corresponds to a first identifier and a second identifier, the first identifier is used to identify a resource index of each communication resource, and the second identifier is used to identify at least one of space domain information and polarization domain information of each communication resource; and
the M communication resources meet any one of the following:
a first identifier corresponding to one of the M communication resources is the same as a first identifier corresponding to a target communication resource, and a second identifier corresponding to one of the M communication resources is different from a second identifier corresponding to the target communication resource, wherein the target communication resource is a communication resource other than the M communication resources in the N communication resources; or
a first identifier corresponding to any one of the M communication resources is different from the first identifier corresponding to the target communication resource.

20. The apparatus according to claim 11, wherein the transceiver is further configured to receive fourth information, wherein the fourth information indicates that P communication resources in the N communication resources are unavailable for measurement, and P is a positive integer.
